(19) United States
(12) Patent Application Publication
(10) Pub. No.: US 2025/0289117 A1
(43) Pub. Date: Sep. 18, 2025

(54) SYSTEM AND METHOD FOR TEACHING A MULTI-ARM ROBOT TO MIMIC HUMAN MOTIONS FOR MAKING COFFEE AND OTHER BEVERAGES

(71) Applicant: Blue Hill Tech, Inc., Seattle, WA (US)

(72) Inventors: Shuo Liu, Kirkland, WA (US); Meng Wang, Seattle, WA (US); Alec Ismael Roig, Seattle, WA (US)

(73) Assignee: Blue Hill Tech, Inc., Seattle, WA (US)

(21) Appl. No.: 18/607,420

(22) Filed: Mar. 15, 2024

(51) Int. Cl. B25J 9/00; A47J 31/52; A47J 44/00; B25J 9/16; B25J 11/00

(52) U.S. Cl. CPC B25J 9/0081; A47J 31/52; A47J 44/00; B25J 9/1682; B25J 11/0045

(57) ABSTRACT

Embodiments described herein provide various techniques and systems for teaching a multi-arm robot to imitate a two-handed beverage-preparation motion sequence performed by a human. In one aspect, a process for teaching a multi-arm robot to imitate the two-handed beverage-preparation motion sequence can begin by recording, in a teaching environment, two or more motion trajectories during the two-handed beverage-preparation motion sequence. The process then transforms the recorded two or more motion trajectories into a motion trajectory of an end effector of a first robotic arm. The process subsequently reproduces the two-handed beverage-preparation motion sequence by executing the transformed motion trajectory on an end effector of the first robotic arm.

### TECHNICAL FIELD

The present disclosure generally relates to robotic systems and techniques for beverage and food preparations in an open environment using computer vision and artificial intelligence, and serving the beverage and food to the consumer with little to no human interaction. More specifically, the present disclosure relates to teaching a multi-arm robot to mimic precise human motions of making milk and coffee beverages.

### BACKGROUND

Generally speaking, making specialty coffee drinks involve one or more human baristas operating a commercial coffee machine. Typical steps of operation include grinding the coffee and collecting the ground coffee in a portable filter basket (known as a portafilter), tamping the coffee in the portafilter, inserting and locking the portafilter in the coffee machine, preparing the coffee by running hot water through the portafilter basket to extract a liquid “shot” of coffee, and finally, pouring the liquid coffee in a cup where it may be mixed with other ingredients. For a milk-coffee drink, additional steps may include steaming and frothing milk in a pitcher, and pouring the steamed/frothed milk into a cup pre-filled with liquid coffee, such as a “shot” or “shots.” Optional latte art may be added to the very top surface of the mixed milk-coffee drink. All of the foregoing steps or tasks are repetitive movements that require basic but consistent motor functions.

Attempts have been made to utilize robotics for performing the above-described beverage preparation tasks. However, such attempts generally require the robotic system to be in a closed box, and as such items and tools in the preparation environment are fixed in places. These configurations allow one to program robots to perform predefined and hardcoded motions that can complete the intended tasks provided that the placements of the required items do not change. However, in realistic working environments such as coffee shops, utensils and cookware are constantly moved about by baristas, and hence even with a robotic assistant, there are significant challenges for the robotic assistant to locate the correct utensil for the desired steps or tasks.

### SUMMARY

Embodiments described herein provide various techniques and systems for teaching a multi-arm robot to imitate a two-handed beverage-preparation motion sequence performed by a human. In one aspect, a process for teaching a multi-arm robot to imitate the two-handed beverage-preparation motion sequence can begin by recording, in a teaching environment, two or more motion trajectories during the two-handed beverage-preparation motion sequence. The process then transforms the recorded two or more motion trajectories into a motion trajectory of an end effector of a first robotic arm. The process subsequently reproduces the two-handed beverage-preparation motion sequence by executing the transformed motion trajectory on an end effector of the first robotic arm.

In some embodiments, the process records the two or more motion trajectories during the two-handed beverage-preparation motion sequence by: (1) coupling a first motion tracker on a first vessel controlled by one hand of the two-handed beverage-preparation motion sequence; (2) coupling a second motion tracker on a second vessel controlled by the other hand of the two-handed beverage-preparation motion sequence; and (3) generating a relative motion trajectory representing relative movements between the first vessel and the second vessel during the two-handed beverage-preparation motion sequence using the first motion tracker and the second motion tracker.

In some embodiments, the process generates the relative motion trajectory representing the relative movements by performing the steps of: (1) using the first motion tracker and a motion capture receiver to generate a first motion trajectory of the first vessel during the two-handed beverage-preparation motion sequence; (2) using the second motion tracker and the motion capture receiver to generate a second motion trajectory of the second vessel during the two-handed beverage-preparation motion sequence; and (3) combining the first motion trajectory and the second motion trajectory to obtain the relative motion trajectory.

In some embodiments, the first motion trajectory and the second motion trajectory are time-synchronized to each other.

In some embodiments, the first motion trajectory and the second motion trajectory are generated with respect to a common reference point located on the motion capture receiver.

In some embodiments, the process transforms the recorded two or more motion trajectories into the motion trajectory of the end effector by transforming the relative motion trajectory into the motion trajectory of the end effector with respect to a world reference frame fixed to the base of the first robotic arm

In some embodiments, the process transform the relative motion trajectory into the motion trajectory of the end effector with respect to the world reference frame by performing the steps of: (1) determining a first transformation from a first reference frame of the first motion tracker attached to the first vessel to the world reference frame; (2) determining a second transformation from a second reference frame of the end effector to the world reference frame; (3) determining a third transformation from the second reference frame of the end effector to the first reference frame of the first motion tracker based on the first transformation and the second transformation; (4) determining a fourth transformation from a third reference frame of the second motion tracker attached to the second vessel to the world reference frame; and (5) applying the third transformation and the fourth transformation to the relative motion trajectory to obtain the transformed motion trajectory of the end effector with respect to the world reference frame,

In some embodiments, prior to determining the second transformation from the second reference frame of the end effector to the world reference frame, the process further includes the steps of: (1) positioning the first vessel in an upright position at an initial location on a table; and (2) engaging the end effector with the first vessel at a designated grasping point on the first vessel.

In some embodiments, the process determines the second transformation from the second reference frame of the end effector to the world reference frame by applying a forward kinematics technique to the first robotic arm after engaging the end effector with the first vessel.

In some embodiments, the process records the two or more motion trajectories during the two-handed beverage-preparation motion sequence by: (1) attaching the second vessel onto a rotational stage; and (2) recording, in the teaching environment, a third motion trajectory of the second vessel representing a rotational motion sequence of the second vessel caused by the other hand.

In some embodiments, the process reproduces the two-handed beverage-preparation motion sequence by further performing the steps of executing the third motion trajectory on an end effector of a second robotic arm. Note that executing the third motion trajectory is time-synchronized with executing the transformed motion trajectory.

In some embodiments, the first vessel is a frothed-milk pouring cup; the second vessel is a receiving cup; and the two-handed beverage-preparation motion sequence is a latte-making motion sequence.

In another aspect, a system for teaching a multi-arm robot to imitate two-handed beverage-preparation motions performed by a human is disclosed. This system includes one or more processors and a memory coupled to the one or more processors. The memory stores a set of instructions that, when executed by the one or more processors, cause the system to: (1) record two or more motion trajectories during the two-handed beverage-preparation motion sequence; (2) transform the recorded two or more motion trajectories into a motion trajectory of an end effector of a first robotic arm; and (3) reproduce the two-handed beverage-preparation motion sequence by executing the transformed motion trajectory on an end effector of the first robotic arm.

In yet another aspect, a system for encoding a synchronized two-handed latte-making motion sequence performed by a human barista is disclosed. This system includes a latte-making stage affixed onto a table, wherein the latte-making stage is integrated with at least one position transducer. The system also includes a receiving cup controlled by one hand of the human barista performing the synchronized two-handed latte-making motion sequence, wherein the receiving cup is attached to a rotation part of the latte-making stage. The system further includes a first motion tracker coupled to a non-rotational part of the latte-making stage. The system additionally includes a pouring pitcher controlled by the other hand of the human barista performing the synchronized two-handed latte-making motion sequence. The system further includes a second motion tracker coupled to the pouring pitcher and a motion capture receiver communicatively coupled to the first motion tracker and the second motion tracker.

In some embodiments, to encode the synchronized two-handed latte-making motion sequence, the first motion tracker and the motion capture receiver are configured to generate a first motion trajectory of the latte-making stage during the synchronized two-handed latte-making motion sequence. Moreover, the second motion tracker and the motion capture receiver are configured to generate a second motion trajectory of the pouring pitcher during the synchronized two-handed latte-making motion sequence. Furthermore, the at least one position transducer is configured to generate a rotational motion trajectory of the receiving cup during the synchronized two-handed latte-making motion sequence. Note that the first motion trajectory, the second motion trajectory, and the rotational motion trajectory encode the synchronized two-handed latte-making motion sequence.

### BRIEF DESCRIPTION OF THE DRAWINGS

The structure and operation of the present disclosure will be understood from a review of the following detailed description and the accompanying drawings in which like reference numerals refer to like parts and in which:

FIG. 1A shows an exemplary two-handed human beverage-preparation motion-sequence recording system for capturing a synchronized two-handed human beverage-preparation motion sequence in accordance with some embodiments described herein.

FIG. 1B shows an alternative two-handed human beverage-preparation motion-sequence recording system for capturing a synchronized two-handed human beverage-preparation motion sequence in accordance with some embodiments described herein.

FIG. 2 presents a flowchart illustrating a process for setting up a teaching environment in preparation for recording a synchronized two-handed latte-drink-creation motion sequence performed by a human user in a controlled environment in accordance with some embodiments described herein.

FIG. 3 presents a flowchart illustrating a process for recording a synchronized two-handed latte-making motion sequence after setting up the recording environment described in FIG. 2 in accordance with some embodiments described herein.

FIG. 4 shows an exemplary recorded trajectory transformation system 400 configured to transform the recorded relative motion trajectory from the reference frame of the recording system of FIG. 1 into the coordinate system of an end effector of a robotic arm prior to executing the recorded relative motion trajectory on the given robotic arm in accordance with some embodiments described herein.

FIG. 5 presents a flowchart illustrating a process for transforming the recorded relative motion trajectory from the reference frame of the recording system into the coordinate system of a robotic arm using the trajectory transformation system of FIG. 4 in accordance with some embodiments described herein.

FIG. 6 presents a flowchart illustrating a process for determining the pose of Tracker2 in the WCS in accordance with some embodiments described herein.

FIG. 7 presents a flowchart illustrating a process for determining the pose of the end effector with respect to Tracker2 when the end effector is engaged with the pouring pitcher in accordance with some embodiments described herein.

FIG. 8 shows an exemplary fully-automated latte-drink-preparation system including at least two robotic arms for automatically executing the recorded and transformed latte-making motion trajectories to create identical latte drinks in accordance with some embodiments described herein.

FIG. 9 presents a flowchart illustrating a process for automatically creating a latte drink by executing the recorded human motion trajectories using the two robotic arms of the disclosed latte-drink-preparation system in accordance with some embodiments described herein.

FIG. 10 presents a flowchart illustrating a process for performing vision-assisted real-time receiving cup detections at the beginning of the automated latte-art creating process of FIG. 9 in accordance with some embodiments described herein.

FIG. 11 presents a flowchart illustrating a process for performing vision-assisted real-time pitcher milk-level detection and variation mitigation during the automated latte-making process of FIG. 9 in accordance with some embodiments described herein.

FIG. 12 illustrates a block diagram of an overall robotic beverage-preparation system for teaching and using a multi-arm robot to imitate two-handed human latte-making motions to create latte drinks in accordance with some embodiments described herein.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

### Terminology

Throughout this patent disclosure, the term “pose” is used to refer to both the positions and orientations of a three-dimensional (3D) object in a given reference frame or in a given coordinate system.

### Overview

A new human motion recording system has developed to capture synchronized two-handed human beverage-preparation motions, such as latte-art motions. To record a synchronized two-handed human latte-making motion sequence, two tracking devices can be attached to a latte-making stage holding a receiving cup and a pouring pitcher, respectively. The two tracking devices can be used to record the relative positions between the pouring pitcher and the receiving cup during the synchronized two-handed human latte-making motion sequence. Additionally, the tilt angles of receiving cup can be recorded time-synchronized with the recordings of the two tracking devices during the synchronized two-handed human latte-making motion sequence.

Some embodiments of this disclosure also provide a calibration system and technique for transforming recorded human motions to be executed by a multi-arm robot system. To do so, multiple tracking devices used during motion recording are also used for calibration. Specifically, one first tracking device is attached to the base of the robot system using a 3D printed calibration tool wherein the pose of the first tracking device in the world coordinate system is known. The second tracking device is attached to the latte art tilting platform at the same position where the same tracking device was used during the recording step. By doing this calibration, the pose of the latte art tilting platform can be obtained and the motion trajectory of the third motion tracking device attached onto a pouring pitcher in the world coordinate system can then be calculated. Following the calibration procedure from the previous patent, the relative pose from the tracking device on the pouring pitcher to the robot end-effector was also known. Consequently, the robot motion trajectory in the world coordinate system was obtained. This disclosure additionally provides a process implemented in software for replaying the latte-making motion trajectory. The new system uses a high frequency feedback loop to control the robot motion and latte art tilting motion simultaneously to mimic identical recorded human motion.

When making latte art by a robot, the actual motion of the robotic arm can be dynamically adjusted to handle unexpected circumstances such as a variation in the frothed milk amount, a variation in cup height (e.g., when multiple cups stacked together), among others. To do so, some embodiments of this disclosure further provide a vision-guided motion trajectory execution system and technique. In some embodiments, prior to executing the latte-making motion trajectories, the frothed milk amount is first detected using a camera mounted on the robotic arm. The recorded latte-making motion is then adjusted based on the difference between the detected frothed milk amount and a reference value. In some embodiments, adjusting the recorded latte-making motion involves changing the pouring pitcher tilt angle and z offset. Concurrently, the amount of cups stacked is also detected. Next, the relative position between the top center of a single cup to the top center of the current number of cups is calculated, which is subsequently used to adjust the recorded latte-making motion.

A similar human-motion capturing platform was disclosed in a pending U.S. patent application entitled, “System and Method for Robotic Food and Beverage Preparation Using Computer Vision,” by inventors Shuo Liu et al., with application Ser. No. 18/273,826, and filed on May 20, 2021. The contents of the above application (referred to as “the previous IP”) are incorporated by reference in its entirety as a part of this document. The previous IP records the one-hand (or “single-hand”) human motion trajectory that operates a pouring pitcher, e.g., to pour frothed milk into a cup. However, in the previous IP, the cup that receives the poured milk is placed at a fixed location on a stationary platform. The recorded single-hand motion trajectory is subsequently replayed by a robotic arm that replicates the learned human motion. The present disclosure additionally includes learning the motion of the second human hand that performs a motion sequence of holding and tilting the cup while receiving the poured milk by the first human hand. As a result, in addition to recording the first human hand (or “the first hand”) motion trajectory, the present disclosure includes additionally recording the second human hand (or “the second hand”) motion trajectory that controls at least the tilt angle of the receiving cup.

Note that one challenge arisen when simultaneously recording both the first-hand motion trajectory and the second-hand motion trajectory is that, the second-hand motion trajectory may include a small amount of lateral movement of the second hand, in addition to the rotational, i.e., the cup-tilting motion. However, when the recorded second-hand motion trajectory is replayed by a tilting arm that has only one degree of freedom, i.e., one degree of rotational motion that is capable of replicating the recorded tilting motion, such a one-degree tilting arm cannot replicate the recorded lateral motions of the second hand.

Note that however, the lateral motions of the latte art platform can generally be considered as a noise motion which would be automatically corrected by the movements of the first hand to keep the positions between the spout of the pitcher and the rim of the cup fixed, i.e., not affected by the lateral motions. For example, a small lateral movement of the table, where the latte art platform and the cup are mounted, can cause the cup to shift away from the pitcher in the first hand. This lateral movement can be caused by applying a force by the second hand on the latte art platform to rotate the cup during the latte-making motion sequence. However, such lateral movements can be automatically corrected by the first hand motion due to human feedback mechanism, which counters the lateral movements to bring the pitcher and the cup back to the same relative positions. This observation of the two-hand latte-making motions with automatic lateral movement correction suggests and indicates that any lateral or otherwise unwanted movement of the latte art platform holding the cup can be compensated by a similar/mirroring movement of the first hand controlling the pitcher. Hence, if we simultaneously record the positions of the cup controlled by the second hand and the positions of the pouring pitcher controlled by the first hand at each timestamp during a latte-making motion sequence, then the relative movements between the cup and the pouring pitcher can be computed. Note that the computed relative movements have compensated for the lateral and other unwanted movements of the second hand.

Consequently, the recorded two-hand latte-making motion sequence can be replayed by two robotic arms: (1) using the first robotic arm to replay the computed relative movements between the two hands that have compensated for the lateral and other unwanted movements of the second hand; and (2) using a simple tilt robotic arm/platform to replicate the recorded rotational/angular trajectory of the cup without additional lateral movements.

Note that because the two hands motions during the two-handed latte-making motion sequence are synchronized, the two recorded trajectories are also synchronized. This means that during the recording process, the pitcher hand constantly and instantly makes real-time compensations to adjust any type of movement from the latte art platform. In particular, if the latte art platform has unwanted movements besides the rotational movements (such as lateral movements), these unwanted movements which are then translated onto the demon cup can be instantly and automatically compensated by the pitcher hand. In other words, if the recorded second trajectory includes unwanted movements of the latte art platform and the demon cup, the recorded first trajectory will include a compensation component to adjust and counter the unwanted movements in the recorded second trajectory. Note that the unwanted movements of the latte art platform can be caused by the second hand that grabs and controls the tilt angles of the demon cup rigidly attached to the rotation stage, which can result in unwanted lateral movements of the entire latte art platform. The unwanted movements of the latte art platform can also be caused by a person, such as the person performing the latte art demo sequence making other unintended contacts with the latte art platform such as bumping into the table.

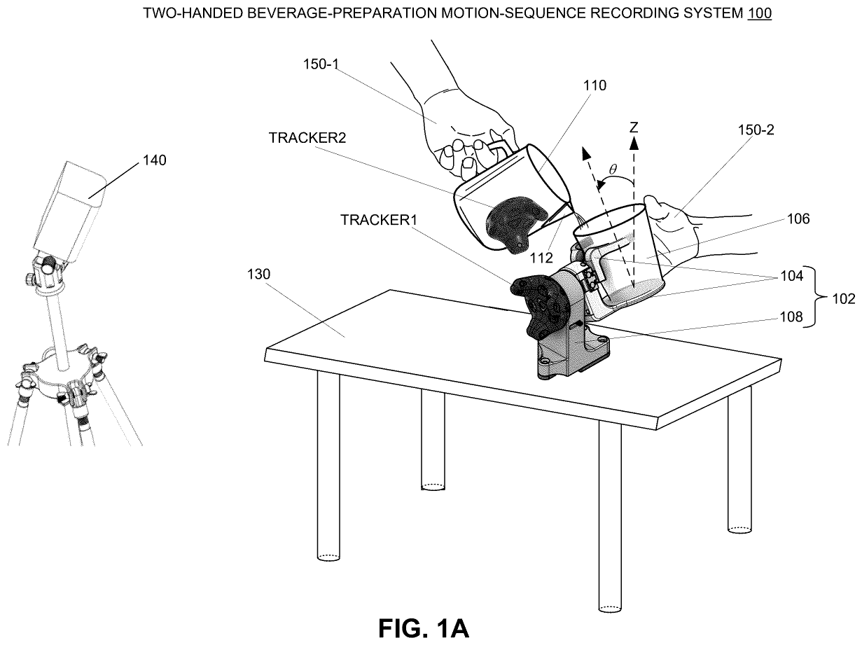

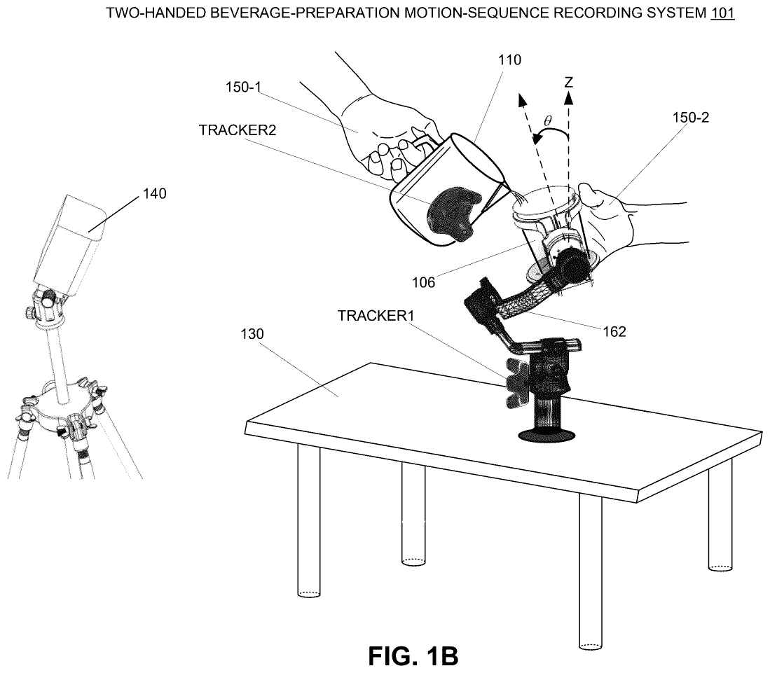

FIG. 1A shows an exemplary two-handed human beverage-preparation motion-sequence recording system 100 (or simply “recording system 100”) for capturing a synchronized two-handed human beverage-preparation motion sequence in accordance with some embodiments described herein. In particular applications, the types of two-handed human beverage-preparation motion sequences that can be recorded using recording system 100 include a two-handed latte-preparation/making sequence performed by a human/person, which is also referred to as a “latte-making motion sequence” below. Generally speaking, a latte-making motion sequence that can be recorded by recording system 100 can include the entirety of a latte-drink preparation procedure from the initial pouring of the milk into a receiving cup until the end of creating the optional latte art on the top surface of the coffee-milk drink. Needless to say, the disclosed recording system 100 can be used to record any portion of a latte-drink preparation procedure, such as the specific step of creating a specific latte art (e.g., a heart, a rosetta, a tulip, or a swan) on the top surface of a latte drink.

However, the types of two-handed human beverage-preparation motion sequences that can be recorded using recording system 100 are not limited to latte-making motion sequences. For example, the two-handed human beverage-preparation motion sequence can also include a two-handed milk-tea preparation sequence performed by a human/person, such as tea-latte drink. Generally speaking, the disclosed recording system 100 can be used to record any beverage-preparation motion procedure that involves pouring one type of liquid into another type of liquid to create a specific visual effect, and/or a specific texture, and/or a specific taste/flavor. For the convenience of discussion, we describe recording system 100 in the context of recording/capturing a latte-making motion sequence below. However, all of the techniques described below in conjunction with recording system 100 can be applied to or easily modified to apply to other types of two-handed beverage-preparation motion sequence described-above, such as the two-handed milk-tea preparation sequences, or other two-handed mixed-drink preparation sequences.

As can be seen in FIG. 1A, recording system 100 includes a recording platform 130, a motion capture receiver 140, a latte-making stage 102, a teaching cup 106, and a pouring pitcher 110. Latte-making stage 102 is disposed on the top of recording platform 130 as support, wherein recording platform 130 can include a table. Latte-making stage 102 further includes a cup holder 104 which can further be composed of a pair of jaws and a bottom support. Hence, teaching cup 106 can be securely held and supported by cup holder 104. Note that throughout this disclosure, teaching cup 106 is also referred to as “receiving cup 106” because it is the cup that receives poured liquid from pouring pitcher 110. As can be seen in FIG. 1A, cup holder 104 together with teaching cup 106 can rotate around an axis coupled to a non-rotating stand 108 of latte-making stage 102. Moreover, cup holder 104 can be tilted into different angular positions θ from the vertical axis by directly applying an external force.

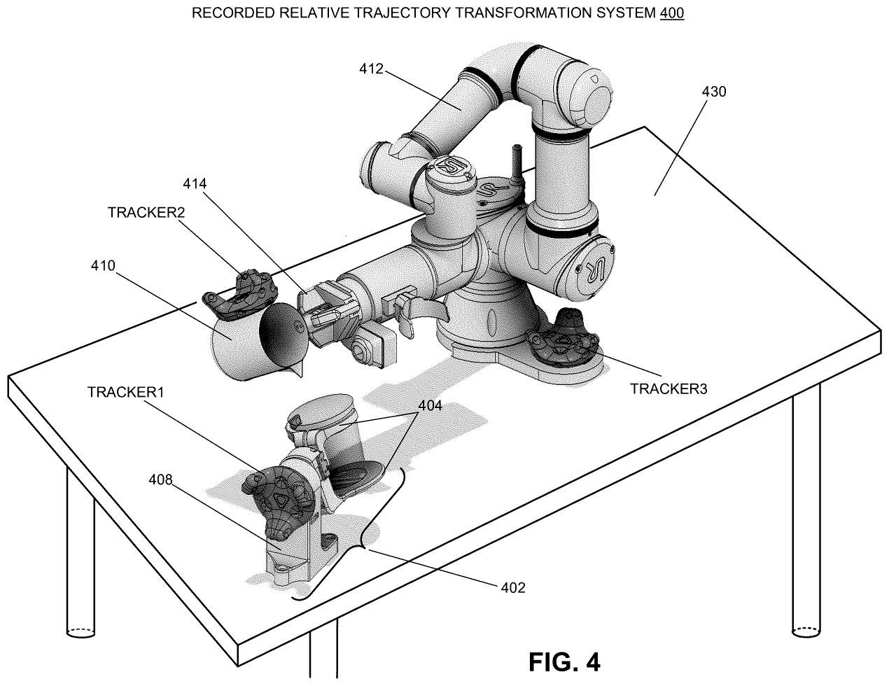

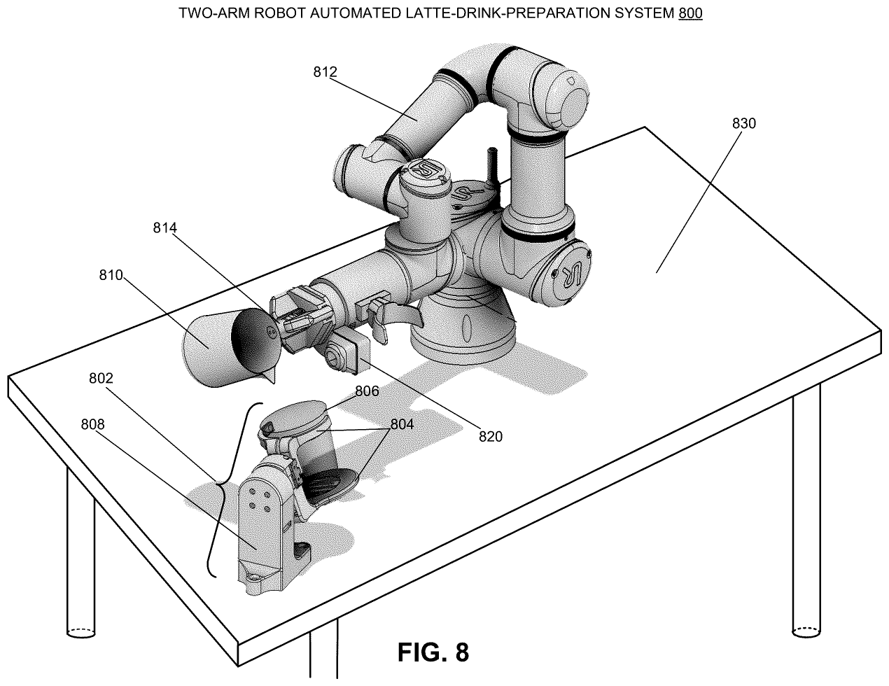

In some embodiments, latte-making stage 102 may be implemented with a single-joint one-degree-of freedom (1-DOF) robotic arm, wherein the end effector of the robotic arm is configured as cup holder 104. In these embodiments, the same type of 1-DOF robotic arm may also be used to implement latte-making stage 402 within trajectory transformation system 400 and latte-making stage 802 within automated latte-drink-preparation system 800 described below in conjunction with FIG. 4 and FIG. 8. Alternatively, latte-making stage 102 can also be implemented with a multi-joint, multi-degrees-of-freedom (multi-DOF) robotic arm without departing from the scope of this disclosure. For example, latte-making stage 102 can also be implemented with a commercial 3, 4, 5, 6, 7, or even more degrees-of-freedom (DOF) robotic arm wherein the end effector of this multi-DOF robotic arm is configured as cup holder 104. In these alternative embodiments, the same type of multi-DOF robotic arm may also be used to implement latte-making stage 402 within trajectory transformation system 400 and latte-making stage 802 within the automated latte-drink-preparation 800 described below in conjunction with FIG. 4 and FIG. 8.

Referring back to FIG. 1A, note that the synchronized latte-making motion sequence is performed by a human user 150 (e.g., a human barista) represented in FIG. 1A by both user 150's left (or right) arm including the left (or the right) hand 150-1 grasping pouring pitcher 110, and user 150's right (or left) arm including the right (or the left) hand 150-2 holding onto teaching cup 106. Before performing the synchronized latte-making motion sequence, receiving cup 106 can be pre-filled with a predetermined amount of coffee such as one or two shots, whereas pouring pitcher 110 can be pre-filled with frothed or steamed milk. During the two-handed latte-making motion sequence, receiving cup 106 is tilted with hand 150-2 in a controlled manner determined by user 150, while receiving frothed or steamed milk from pouring pitcher 110 poured with hand 150-1 in a controlled manner determined by user 150.

Moreover, recording system 100 includes a first 3D pose/motion tracker (also referred to as “Tracker1” hereinafter) which is affixed onto the non-rotating stand 108 of latte-making stage 102 and physically separated from cup holder 104 and receiving cup 106. During a synchronized two-handed latte-making motion sequence, Tracker1 is used to track movements of latte-making stage 102 and transmit positional signals (e.g., in the form of infrared lights) to a motion capture receiver 140. Recording system 100 further includes a second 3D pose/motion tracker (also referred to as “Tracker2” hereinafter) which is affixed onto pouring pitcher 110 and is used to track the movements of pouring pitcher 110 and transmit positional signals (e.g., in the form of infrared lights) to motion capture receiver 140 during the synchronized two-handed latte-making motion sequence.

Note that motion capture receiver 140 is positioned at a fixed location within the recording system 100 at some distance away from recording platform 130, latte-making stage 102, and pouring pitcher 110. Motion capture receiver 140 is used in tandem with Tracker1 and Tracker2 to capture/receive the positional signals from both Tracker1 and Tracker2, and subsequently compute the 3D poses of Tracker1 and Tracker2 based on the received positional signals. In some embodiments, motion capture receiver 140 is configured to emit light signals (e.g., infrared light) to be detected by Tracker1 and Tracker2. Note that motion capture receiver 140 also serves as a common reference point for both Tracker1 and Tracker2 during the recording of the latte-making motion sequence. Note also that Tracker1, Tracker2 and motion capture receiver 140 form a motion tracking and recording subsystem, which may be implemented with one of the following existing commercial motion capturing systems: VICON, HTC VIVE, MOCAP, and OptiTrack, among others. This motion tracking and recording subsystem should be able to provide sufficient accuracy (typically below 1 millimeter). We now describe embodiments of recording a synchronized latte-making motion sequence using recording system 100 in more detail.

As can be seen in FIG. 1A, Tracker1 which is affixed onto non-rotating stand 108 of latte-making stage 102, does not rotate along with rotatory cup holder 104 and receiving cup 106 controlled by hand 150-2 of user 150. The rotational motion trajectory (or simply “rotational trajectory”) of cup holder 104 and hence that of receiving cup 106, can be recorded by an angular transducer/sensor (not explicitly shown) integrated with latte-making stage 102 and mechanically coupled to cup holder 104. During the recording of the latte-making motion sequence using recording system 100, Tracker1 and motion capture receiver 140 can be used to record the non-rotational movements of latte-making stage 102, including motions caused by any movement of recording platform 130 (already described above). Note that the generated 3D poses of Tracker1 have a common reference with respect to a point (i.e., the reference point) within motion capture receiver 140. Tracker1 can generate 3D pose signals of receiving cup 106 and transmit the 3D pose signals toward motion capture receiver 140.

Motion capture receiver 140 receives the 3D pose signals from Tracker1 and subsequently computes and generates a time sequence of 3D-pose data collectively referred to as “the first motion trajectory” (hereinafter referred to as “J1”) of the latte-making stage 102/receiving cup 106 during the latte-making motion sequence. Note that the generated 3D poses of Tracker1 in J1 are computed with respect to a common reference point of a reference coordinate system (or “RCS”) within motion capture receiver 140. In some embodiments, the 3D-pose of Tracker1 with respect to the RCS can be expressed in terms of a homogeneous transformation matrix T_{R}^{Tkr1} as:

$${T}_{R}^{T k r 1} = [ \begin{matrix} & & & X \\ & ( {1}_{} ) & & Y \\ & & & Z \\ 0 & 0 & 0 & 1\end{matrix} ] , \qquad ( 1 )$$

wherein [symbol] ₁ is a 3×3 rotation matrix. Moreover, trajectory J1 of Tracker1 with respect to the RCS, which is a time series of the 3D-poses, can be defined as:

$$J 1 = {J}_{R}^{Tkr 1} = \{ i = 1 , 2 , … , n \vert {T}_{R}^{T k r 1} \vert {t}_{i} \} , \qquad ( 2 )$$

wherein {i=1, 2, . . . , n|tᵢ} is a sequence of timestamps of the corresponding time series of poses, and T_{R}^{Tkr1}|t is the pose of Tracker1 at a given timestamp t with respect to the RCS. Because Tracker1 and non-rotating stand 108 of latte-making stage 102 move in unison, J1 can accurately represent the non-rotational motion trajectory of any given point on latte-making stage 102, including the lip of receiving cup 106. Note also that J1 can include the movements of both non-rotating stand 108 and motion capture receiver 140.

In some embodiments, instead of separately using Tracker1 to track and detect the non-rotational movements of receiving cup 106 and the embedded angular sensor/transducer to detect the rotational movements of receiving cup 106, Tracker1 can be directly affixed onto the receiving cup 106 so that it can be used to track and detect the combined rotational and non-rotational movements of receiving cup 106. However, such a motion-sensing/trajectory recording configuration can cause the light signals from motion capture receiver 140 to be blocked due to the rotational movements of Tracker1 in tandem with receiving cup 106 during the recording of the latte-making motion sequence.

Further referring to FIG. 1A, note that Tracker2, which is affixed onto pouring pitcher 110, is used to track and detect movements of pouring pitcher 110. During the recording of the latte-making motion sequence, Tracker2 tracks 3D movements/poses of pouring pitcher 110, generates 3D pose signals of pouring pitcher 110 and transmits the 3D pose signals toward motion capture receiver 140. Specifically, the tracked movements of pouring pitcher 110 include both milk pouring motions and optional latte-art creation motions of the latte-making motion sequence performed with hand 150-1 of user 150.

Motion capture receiver 140 receives the 3D pose signals from Tracker2 and subsequently computes and generates a sequence of 3D pose data collectively referred to as the second motion trajectory (hereinafter referred to as “J2”) of pouring pitcher 110. Note that the generated 3D poses of Tracker2 in J2 are computed with respect to the same reference point and reference coordinate system (RCS) on motion capture receiver 140, which is also the same reference point and RCS for J1. In some embodiments, the 3D-pose of Tracker2 with respect to the RCS can be generally expressed in terms of a homogeneous transformation matrix T_{R}^{Tkr2} as:

$${T}_{R}^{T k r 2} = [ \begin{matrix} & & & X \\ & ( {2}_{} ) & & Y \\ & & & Z \\ 0 & 0 & 0 & 1\end{matrix} ] , \qquad ( 3 )$$

wherein [symbol] ₂ is a 3×3 rotation matrix. Moreover, trajectory J2 of Tracker2 with respect to the RCS, which is a time series of the 3D-poses, can be defined as:

$$J 2 = {J}_{R}^{Tkr 2} = \{ i = 1 , 2 , … , n \vert {T}_{R}^{T k r 2} \vert {t}_{i} \} , \qquad ( 4 )$$

wherein {i=1, 2, . . . , n|tᵢ} is a sequence of timestamps of the corresponding time series of poses, and T_{R}^{Tkr2}|t is the pose of Tracker2 at a given timestamp t with respect to the RCS. Because Tracker2 and pouring pitcher 110 move in unison, J2 can accurately represent the 3D motion trajectory of any given point on pouring pitcher 110, such as the spout 112 of pouring pitcher 110 positioned in the vicinity of the lip of receiving cup 106. Note also that J2 includes the movements of both pouring pitcher 110 and motion capture receiver 140 itself.

As such, the motion tracking and recording subsystem including Tracker1, Tracker2, and motion capture receiver 140 generate time-synchronized trajectories J1 and J2 of latte-making stage 102 and pouring pitcher 110 with respect to the common reference point on motion capture receiver 140. Further referring to FIG. 1A, while J1 and J2 are being recorded during the latte-making motion sequence, the rotational trajectory (also referred to as “J3”) of receiving cup 106 can be simultaneously recorded by the angular transducer embedded in the latte-making stage 102. Specifically, the rotational movements of the rotational stage are caused by user 150 using hand 150-2 to rotate the receiving cup with respect to a vertical axis (i.e., Z-direction) to generate a sequence of tilt angles of the receiving cup with respect to the vertical axis. Note that this rotational trajectory J3 represents a relative motion between receiving cup 106 tracked with Tracker2 and non-rotating stand 108 tracked with Tracker1. Again, J3 is time-synchronized with both J1 and J2.

Once J1 and J2 have been recorded, the relative motions, i.e., a relative motion trajectory between Tracker2 and Tracker1 can be conveniently obtained as the difference between the two recorded trajectories J2 and J1, wherein this relative motion trajectory of Tracker2 with respect to Tracker1 can be denoted as J_{Tkr1}^{Tkr2}. In some embodiments, to compute J_{Tkr1}^{Tkr2} based on J1 and J2, i.e., J_{R}^{Tkr1} and J_{R}^{Tkr2}, we can first obtain the reverse trajectory of J1, i.e., J_{R}^{Tkr1}. Next, the relative motion trajectory of Tracker2 with respect to Tracker1 can be expressed as:

$${J}_{T k r 1}^{T k r 2} = {J}_{T k r 1}^{R} \times {J}_{R}^{Tkr 2} . \qquad ( 5 )$$

Note that J_{Tkr1}^{Tkr2} corresponds to a relative motion trajectory between a point on pouring pitcher 110 (e.g., the spout 112 of pouring pitcher 110) and a point on receiving cup 106 (e.g., the lip of receiving cup 106), but without the tilt motions of receiving cup 106. However, the combined relative motion trajectory J_{Tkr1}^{Tkr2} and the rotational trajectory J3 of receiving cup 106 encodes the entire two-handed latte-making motion sequence performed by user 150.

During a subsequent deployment on a multi-arm robot latte-drink platform, the relative motion trajectory J_{Tkr1}^{Tkr2} can be automatically replayed by a first robotic arm controlling a pouring pitcher in place of hand 150-1 of user 150 in recording system 100, whereas a second robotic arm configured identically or similarly to latte-making stage 102 in system 100 can automatically perform the recorded rotational trajectory J3 in place of hand 150-2 of user 150 in recording system 100. Note that this replay scheme is equivalent to independently replaying the two recorded trajectories J_{Tkr1}^{Tkr2} and J3 on the first robotic arm and the second robotic arm, respectively. As described above, this relative trajectory J_{Tkr1}^{Tkr2} allows the lateral and other unwanted movements of latte-making stage 102 tracked by Tracker1 during the latte-making motion sequence to be automatically canceled or compensated for. Notably, by directly transferring/replaying the computed relative trajectory J_{Tkr1}^{Tkr2} onto a multi-arm robot latte art system, there is no need to calibrate either Tracker1 or Tracker2 during the above-described recording process of J1 and J2, because both J1 and J2 are recorded with respect to the same reference point on motion capture receiver 140.

Note that above described procedures including teaching, by user 150 to perform the synchronized two-handed latte-making motion sequence, and recording a set of motion trajectories J1, J2, and J3, can be repeated multiple times. Each repetition made by user 150 represents a different attempt to teach the two-handed latte-making motion sequence. Meanwhile, the set of trajectories J1, J2, and J3 can be repeatedly recorded during each repetition by user 150 until an optimal result of the latte drink, including the latte art, can be obtained inside the receiving cup 106.

FIG. 1B shows an alternative two-handed human beverage-preparation motion-sequence recording system 101 (or simply “recording system 101”) for capturing a synchronized two-handed human beverage-preparation motion sequence in accordance with some embodiments described herein. Note that in recording system 101, the 1-DOF latte-making stage 102 in recording system 100 is replaced with a 3-DOF latte-making stage 162 based on a 3-DOF gimbal arm. During the two-handed latte-making motion sequence, receiving cup 106 is tilted or otherwise manipulated in a controlled manner by hand 150-2 of user 150 to receive the frothed milk from pouring pitcher 110 controlled by hand 150-1 of user 150. Because there degrees of freedom are allowed to manipulate receiving cup 106 in recording system 101, user 150 can tilt receiving cup 106 significantly more freely than in recording system 100 during the two-handed latte-making motion sequence. Moreover, instead of recording a simple rotational trajectory J3, 3 position sensors in 3-DOF latte-making stage 162 can independent record three trajectories, wherein the combined motion sequence of the three recorded trajectories at the end effector of latte-making stage 162 represents the significantly more complex trajectory of receiving cup 106 created by hand 150-2 during the two-handed latte-making motion sequence. Note that recording system 101 also includes Tracker1 attached to the base of latte-making stage 162 for recording trajectory J1 during the two-handed latte-making motion sequence, and Tracker1 attached to pouring pitcher 110 for recording trajectory J2 during the two-handed latte-making motion sequence.

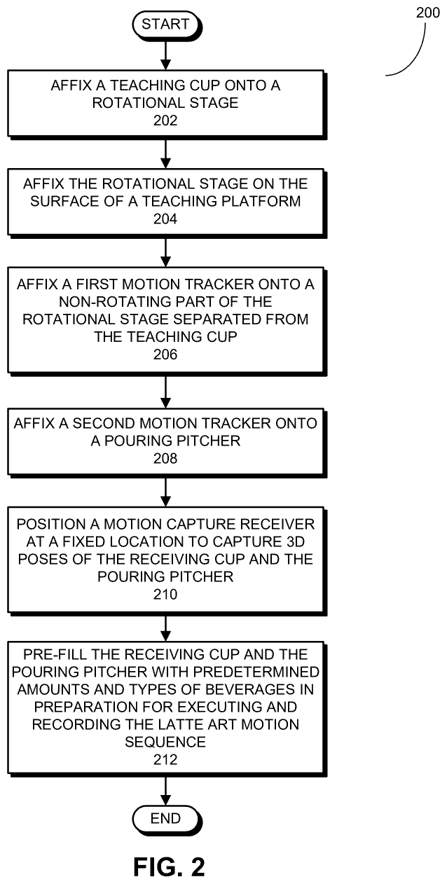

FIG. 2 presents a flowchart illustrating a process 200 for setting up a teaching environment in preparation for recording a synchronized two-handed latte-making motion sequence performed by a human user in a controlled environment in accordance with some embodiments described herein. In one or more embodiments, one or more of the steps in FIG. 2 may be omitted, repeated, and/or performed in a different order. Accordingly, the specific arrangement of steps shown in FIG. 2 should not be construed as limiting the scope of the technique.

Process 200 begins by affixing a receiving cup onto a rotational stage which includes an embedded angular sensor configured to record rotational movements of the rotational stage (step 202). For example, the rotational stage can be latte-making stage 102 configured with rotatory cup holder 104 to hold and support the receiving cup as shown in FIG. 1A. During the recording of the two-handed latte-making motion sequence, rotational movements of the rotational stage represent the sequence of tilt angles of the receiving cup with respect to a vertical axis (i.e., Z-direction) controlled by the human user. Next, the rotational stage is affixed onto the top surface of a recording platform (step 204). For example, the recording platform can be recording platform 130 described in conjunction with FIG. 1A.

Process 200 also affixes a first motion tracking device (e.g., Tracker1 in FIG. 1A) onto a non-rotating part of the rotational stage separated from the receiving cup (step 206). As such, the first motion tracking device is isolated from the rotational movements of the rotational stage and the receiving cup. Hence, the first motion tracking device can be used to detect and track non-rotational motions of the rotational stage, such as lateral movements caused by the teaching platform. In some embodiments, the first motion tracking device can also be affixed directly onto the teaching platform. In such embodiments, the first motion tracking device moves in tandem with the teaching platform and is also isolated from the rotational motions of the rotational stage. In some other embodiments, the first motion tracking device can be directly affixed onto the rotational part of the rotational stage and hence can be used to detect and track both the non-rotational movements of the rotational stage and the tilting motions of receiving cup. However, making the first motion tracking device to rotate alongside the receiving cup can lead to a higher probability of optical signal occlusions for the first motion tracking device to receive and transmit light signals.

Process 200 further affixes a second motion tracking device (e.g., Tracker2 in FIG. 1A) onto a pouring pitcher so the second motion tracking device and the pouring pitcher move in unison (step 208). Note that the second motion tracking device can be either attached to the side wall of the pouring pitcher or to the bottom of the pouring pitcher. Hence, the second motion tracking device can precisely detect and track the motion trajectory of the pouring pitcher during the two-handed latte-making motion sequence. Next, process 200 positions a motion capture receiver at a fixed location within the teaching environment away from the teaching platform, the rotational stage, and the pouring pitcher, wherein the motion capture receiver is used in tandem with the first and the second motion tracking devices to capture the 3D poses of the receiving cup and the pouring pitcher (step 210). Exemplary implementations of this motion capture receiver have been described above in terms of motion capture receiver 140 in conjunction with FIG. 1A. Process 200 subsequently pre-fills the receiving cup and the pouring pitcher with predetermined amounts and types of beverages in preparation for executing and recording the synchronized latte-making motion sequence (step 212). For example, the receiving cup may be pre-filled with one or two shots of coffee espresso, and the receiving cup can be pre-filled with steamed or frothed milk.

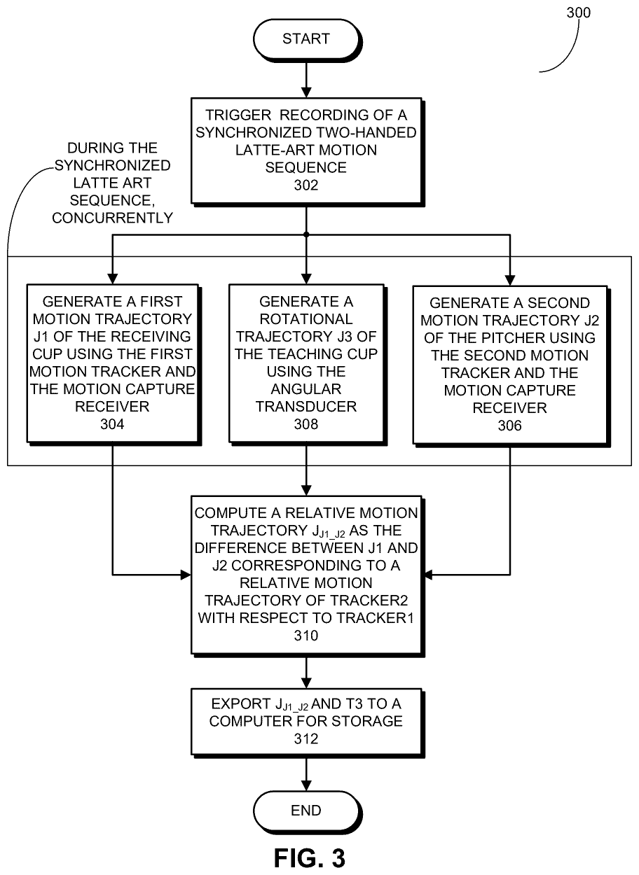

FIG. 3 presents a flowchart illustrating a process 300 for recording a synchronized two-handed latte-making motion sequence after setting up the recording environment described in FIG. 2 in accordance with some embodiments described herein. In one or more embodiments, one or more of the steps in FIG. 3 may be omitted, repeated, and/or performed in a different order. Accordingly, the specific arrangement of steps shown in FIG. 3 should not be construed as limiting the scope of the technique.

Process 300 may begin by triggering the recordings of a synchronized two-handed latte-making motion sequence (step 302). As described above, the synchronized latte-making motion sequence to be recorded involves a human user using one hand to hold the pouring pitcher and control the pouring of a liquid (e.g., frothed milk) into the receiving cup, while using the other hand to control the tilt angles of the receiving cup held by the rotational stage while receiving the poured liquid (e.g., frothed milk) from the pouring pitcher. In some embodiments, the pouring pitcher is initially set on top of the teaching platform and the recording process may be triggered at the moment when the pouring pitcher is picked up by the human user.

During the synchronized latte art demo sequence, process 300 generates a first motion trajectory “J1” of the receiving cup using the first motion tracking device and the motion capture receiver (step 304). Specifically, trajectory “J1” records any unwanted movements from the rotational stage and the motion capture receiver. Additionally and concurrently, process 300 generates a second motion trajectory “J2” of the pouring pitcher using the second motion tracking device and the motion capture receiver (step 306). Specifically, trajectory “J2” of the pouring pitcher is caused by the controlled pouring motion sequence performed by the human user with one hand, which can include a milk-pouring motion sequence followed by a latte-art creation motion sequence. Additionally and concurrently, process 300 generates a rotational trajectory “J3” of the receiving cup using the angular transducer embedded in the latte-making stage (step 308). Specifically, trajectory “J3” of the receiving cup is caused by the controlled tilt motion sequence of the receiving cup performed by the human user with the other hand. Note that all three trajectory generation/recording steps 304-308 are performed in parallel and in a time-synchronized manner.

Because both the first motion trajectory J1 and the second motion trajectory J2 are generated with respect to the same reference point on the motion capture receiver, and further because J1 and J2 are time-synchronized, process 300 further computes a relative motion trajectory J_{Tkr1}^{Tkr2} as the difference between J1 and J2 corresponding to a relative motion trajectory of Tracker2 with respect to Tracker1 (step 310). Finally, the generated relative motion trajectory J_{Tkr1}^{Tkr2} and rotational trajectory J3 can be exported to a computer system for storage (step 312). Note that each of the trajectories J_{Tkr1}^{Tkr2} and J3 is a time-series data sequence.

During a subsequent deployment, the recorded relative motion trajectory J_{Tkr1}^{Tkr2} and rotational trajectory J3 can be respectively transferred onto two robotic arms of a fully automated latte-art making environment, wherein the two robotic arms can be independently programmed and controlled to replay the relative motion trajectory J_{Tkr1}^{Tkr2} and rotational trajectory J3, respectively. Specifically, one of the two robotic arms can be programmed to grasp a pouring pitcher and control the pouring pitcher to execute the relative motion trajectory J_{Tkr1}^{Tkr2}. Concurrently, a second robotic arm is configured as the latte-making stage, and programmed to execute the recorded rotational trajectory J3 on a receiving cup held by the second robotic arm. Note that this replay scheme can be configured to be equivalent to independently replaying the two recorded trajectories J2 and J3 on the two robotic arms.

Note that when using a robotic arm to execute the recorded relative motion trajectory J_{Tkr1}^{Tkr2}, the computer-generated time-series data points corresponding to the relative motion trajectory J_{Tkr1}^{Tkr2} are implemented as the poses of the end effector of the robotic arm. However, an end effector of a robotic arm executes a given pose with respect to the world coordinate system (WCS), e.g., the center of the robotic arm's base. This means that each pose data point in the relative motion trajectory J_{Tkr1}^{Tkr2}, which was generated as a relative pose, must be transformed into a corresponding pose of the end effector with respect to the WCS. The transformed replay trajectory based on the relative motion trajectory J_{Tkr1}^{Tkr2} into the WCS of the end effector can be denoted as T_{W}^{EE}. However, to transform J_{Tkr1}^{Tkr2} into T_{W}^{EE} for the purpose of accurately reproducing the recorded two-handed latte-making motion sequence, a calibration-transformation procedure involving using multiple 3D pose/motion trackers has to be developed.

FIG. 4 shows an exemplary recorded trajectory transformation system 400 configured to transform the recorded relative motion trajectory J_{Tkr1}^{Tkr2} from the reference frame of the recording system 100 into the coordinate system of the end effector of a robotic arm prior to executing the recorded relative motion trajectory on the given robotic arm in accordance with some embodiments described herein. As can be seen in FIG. 4, recorded trajectory transformation system 400 includes a table 430, a latte-making stage 402 implemented with a first robotic arm (also referred to as “the first robotic arm 402” hereinafter), and a second robotic arm 412, wherein both robotic arms 402 and 412 are disposed on the top of table 430. Note that the first robotic arm 402 is substantially the same as latte-making stage 102 in recording system 100, which is composed of a cup holder 404, a non-rotating stand 408 attached to the surface of table 430, and a first 3D pose/motion tracker (Tracker1) attached to the non-rotating stand of latte-making stage 402. For the accuracy of the calibration and transformation, Tracker1 on latte-making stage 402 should be placed at the same position as Tracker1 on latte-making stage 102 in recording system 100. In some embodiments, Tracker1 in transformation system 400 can be the same tracker as Tracker1 in recording system 100. In other embodiments, Track1 in transformation system 400 is an identical copy of the same type of motion tracker as Tracker1 in recording system 100.

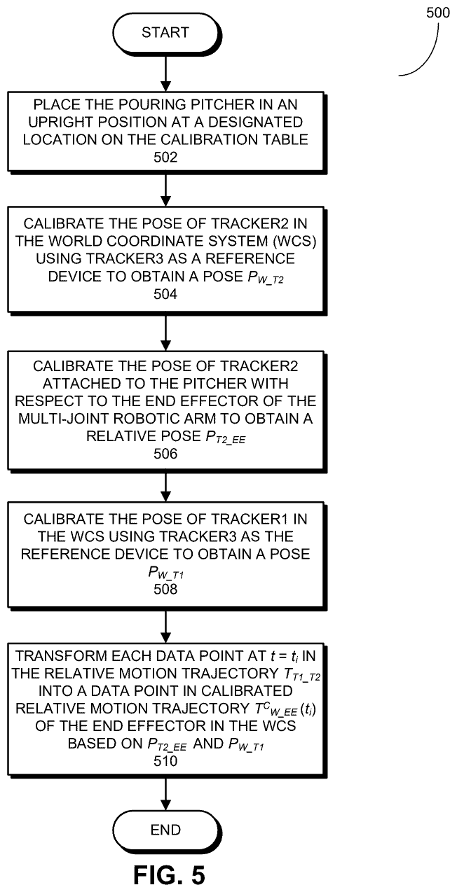

Note that the second robotic arm 412 is a multi-DOF robotic arm that includes an end effector 414 firmly grasping and holding a pouring pitcher 410, wherein pouring pitcher 410 can be the same pouring pitcher or an identical copy of pouring pitcher 110 in recording system 100. In various embodiments, robotic arm 412 can be a 6-DOF robotic arm, a 7-DOF robotic arm, or even more DOF robotic arm. As can be seen FIG. 4, transformation system 400 also includes a second 3D pose/motion tracker (Tracker2) affixed onto pouring pitcher 410 at the same position as Tracker2 on pouring pitcher 110 in recording system 100. In some embodiments, Tracker2 in transformation system 400 can be the same tracker as Tracker2 in recording system 100. In other embodiments, Track2 in transformation system 400 is an identical copy of Tracker2 in recording system 100. Hence, the two tracking devices Tracker1 and Tracker2 used in recording system 100 are reused in transformation system 400. Additionally, transformation system 400 includes a third pose/motion tracking device (also referred to as “Tracker3” hereinafter) placed at a fixed location in the WCS, such as being mounted onto the base of the second robotic arm. Alternatively, Tracker3 can be mounted onto the top surface of table 430 near the base of the second robotic arm 412. Note that in each of the above embodiments, the pose of Tracker3 in the WCS (e.g., the base robotic arm 412) is known. We now describe techniques of transforming the recorded relative motion trajectory J_{Tkr1}^{Tkr2} from recording system 100 into the coordinate system of the end effector of robotic arm 412 using the disclosed trajectory transformation system 400. FIG. 5 presents a flowchart illustrating a process 500 for transforming the recorded relative motion trajectory J_{Tkr1}^{Tkr2} from the reference frame of the recording system into the coordinate system of a robotic arm using the trajectory transformation system 400 of FIG. 4 in accordance with some embodiments described herein. In one or more embodiments, one or more of the steps in FIG. 5 may be omitted, repeated, and/or performed in a different order. Accordingly, the specific arrangement of steps shown in FIG. 5 should not be construed as limiting the scope of the technique. Hence, process 500 is described and should be understood in the context of trajectory transformation system 400 in FIG. 4,

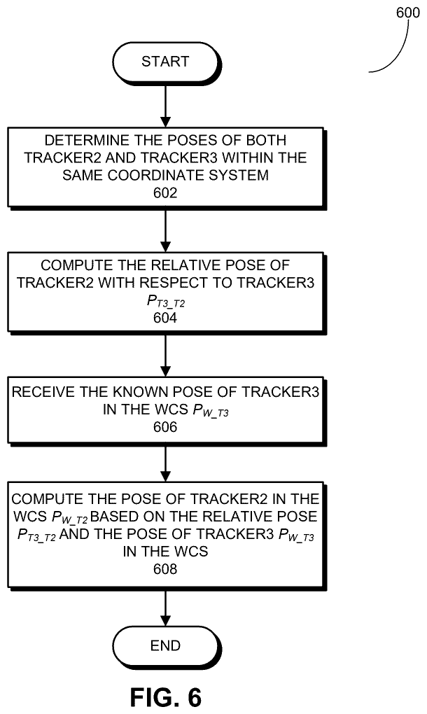

Process 500 may begin by placing pouring pitcher 410 in an upright position at an initial location on the surface of table 430 (step 502). For example, the initial location can be located within a working range of the second robotic arm 412, wherein the initial location is neither too close nor too far from the first robotic arm 402 for the optimal efficiency and reachability. After placing the pouring pitcher 410 at the designated location, the pose of Tracker2 on pitcher 410 within the transformation system 400 is also set. Next, process 500 calibrates the pose of Tracker2 in the WCS using Tracker3 as a reference device to obtain the pose of Tracker2 in the WCS, denoted as “T_{W}^{Tkr2}” (step 504). FIG. 6 presents a flowchart illustrating a process 600 for determining the pose of Tracker2 in the WCS in accordance with some embodiments described herein. In one or more embodiments, one or more of the steps in FIG. 6 may be omitted, repeated, and/or performed in a different order. Accordingly, the specific arrangement of steps shown in FIG. 6 should not be construed as limiting the scope of the technique.

Process 600 may begin by determining the poses of both Tracker2 and Tracker3 within the same coordinate system (step 602). For example, the poses of Tracker2 and Tracker3 can be captured and computed with respect to a common reference point using a common motion capture receiver (e.g., motion capture receiver 140) described above in conjunction with FIG. 1A. Process 600 can then compute the relative pose of Tracker2 with respect to Tracker3, denoted as “T_{Tkr3}^{Tkr2}” (step 604). Next, process 600 receives the known pose of Tracker3 in the WCS, denoted as “T_{W}^{Tkr3}” (step 606). Subsequently, process 600 computes the pose of Tracker2 in the WCS T_{W}^{Tkr2} based on the relative pose T_{Tkr3}^{Tkr2} and the pose of Tracker3 T_{W}^{Tkr3} in the WCS (step 608).

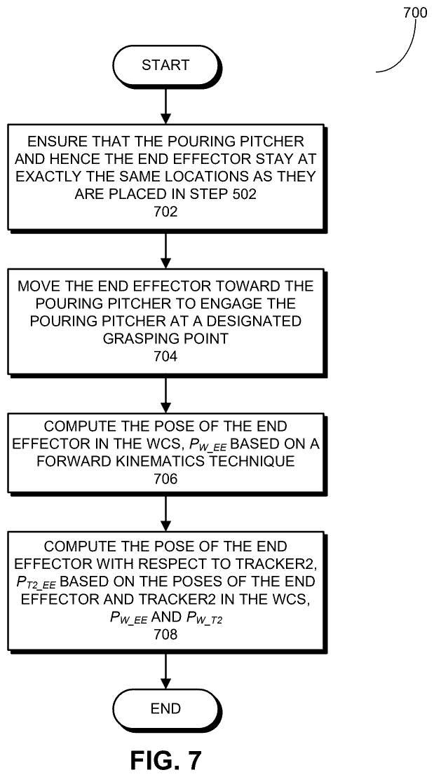

Returning to FIG. 5, after determining T_{W}^{Tkr2} process 500 next calibrates the pose of Tracker2, which is attached to pouring pitcher 410, with respect to end effector 414 of multi-joint robotic arm 412 (step 506). FIG. 7 presents a flowchart illustrating a process 700 for determining the pose of the end effector 414 with respect to Tracker2 when the end effector 414 is engaged with pouring pitcher 410 in accordance with some embodiments described herein. In one or more embodiments, one or more of the steps in FIG. 7 may be omitted, repeated, and/or performed in a different order. Accordingly, the specific arrangement of steps shown in FIG. 7 should not be construed as limiting the scope of the technique.

Process 700 may begin by ensuring that pouring pitcher 410 and hence end effector 414 stay at exactly the same locations as they are placed in step 502 (step 702). Next, process 700 moves end effector 414 toward pouring pitcher 410 to engage the pouring pitcher at a designated grasping point on pouring pitcher 410 (e.g., a grasping stub on pouring pitcher 410) (step 704). Note that process 704 can be implemented either with a computer program of robotic arm 412 that drives end effector 414 or by a human, such as user 150 that causes the end effector 414 to move from an original position to the location of the designated grasping point by hand. Next, process 700 computes the pose of end effector 414 in the WCS, denoted as “T_{W}^{EE}” based on a forward kinematics technique (step 706). Process 700 then receives the determined pose of Tracker2 in the WCS T_{W}^{Tkr2} in step 504 of process 500 (step 706). Subsequently, process 700 computes the pose of end effector 414 with respect to Tracker2 based on the computed poses T_{W}^{Tkr2} and T_{W}^{EE} of end effector 414 and Tracker2 in the WCS (step 708). We denote the computed relative pose of end effector 414 with respect to Tracker2 and as “T_{Tkr2}^{EE}.”

Returning to FIG. 5, after determining T_{EE}^{Tkr2}, process 500 can then calibrate the pose of Tracker1 in the WCS using Tracker3 as the reference device to obtain the pose of Tracker1 in the WCS, denoted as “T_{W}^{Tkr1}” (step 508). Note that process 600 for determining the pose of Tracker2 in the WCS can be applied in step 508. Specifically, the poses of both Tracker1 and Tracker3 may be first determined with respect to a common reference point, e.g., by capturing and computing the poses of Tracker1 and Tracker3 using a common motion capture receiver (e.g., motion capture receiver 140) described above in conjunction with FIG. 1A. As a result, the relative pose of Tracker1 with respect to Tracker3, denoted as “T_{Tkr3}^{Tkr1}”, can be obtained. Because the pose of Tracker3 in the WCS, i.e., T_{W}^{Tkr3} is already known, the pose of Tracker1 in the WCS, i.e., T_{W}^{Tkr1} can be computed based on the obtained relative pose T_{Tkr3}^{Tkr1} and the pose of Tracker3, i.e., T_{W}^{Tkr3} in the WCS.

After obtaining the relative pose T_{Tkr2}^{EE} and the pose of Tracker1 T_{W}^{Tkr1} in the WCS, each data point at a given timestamp tᵢ (i=1, 2, . . . , n) in the relative motion trajectory J_{Tkr1}^{Tkr2} can be transformed into a data point within a transformed motion trajectory at a given time point tᵢ of end effector 414 of robotic arm 410 in the WCS, thereby obtaining the transformed motion trajectory of end effector 414 with respect to the WCS, denoted as “J_{W}^{EE}” (step 510). Similarly to J1 and J2, J_{W}^{EE} can be expressed as:

$${J}_{W}^{E E} = \{ i = 1 , 2 , … , n \vert {T}_{W}^{E E} \vert {t}_{i} \} , \qquad ( 6 )$$

wherein {i=1, 2, . . . , n|tᵢ} is a sequence of timestamps of the corresponding time series of poses of the end effector, and T_{W}^{EE}(tᵢ) is the pose of the end effector at a given timestamp tᵢ with respect to the WCS. Consequently, each pose T_{W}^{EE}|t; and hence the transformed relative motion trajectory J_{W}^{EE} can be computed using the determined poses T_{Tkr2}^{EE}|tᵢ and T_{W}^{Tkr1}|tᵢ through two transformations operating from right to left using the following equation:

$${J}_{W}^{E E} = {T}_{W}^{T k r 1} \vert {t}_{i} \times {J}_{T k r 1}^{T k r 2} \times {T}_{Tkr 2}^{E E} \vert {t}_{i} , \{ {t}_{i} \vert i = 1 , 2 , … , n \} . \qquad ( 7 )$$

After the above calibration and transformation steps, the recorded relative motion trajectory J_{Tkr1}^{Tkr2} is accurately transformed into a robot motion trajectory in the WCS. Subsequently, the transformed relative motion trajectory and the recorded rotational trajectory can be transferred onto a disclosed multi-arm robot system configured to automatically execute the transformed relative motion trajectory and the recorded rotational trajectory, i.e., to replay the recorded two-handed human latte-making motion trajectories in the multi-arm robot system.

FIG. 8 shows an exemplary fully-automated latte-drink-preparation system 800 including at least two robotic arms for automatically executing the recorded and transformed human latte-making motion trajectories to create identical latte drinks in accordance with some embodiments described herein. As can be seen in FIG. 8, automated latte-drink-preparation system 800 includes a table 830, a latte-making stage 802 implemented with a first robotic arm (also referred to as “first robotic arm 802” hereinafter), and a pouring arm 812 implemented with a second robotic arm (also referred to as “second robotic arm 812” hereinafter), wherein both robotic arms are disposed on the top of table 430. Note that the configuration of automated latte-drink-preparation system 800 can be substantially identical to the configuration of trajectory transformation system 400, which includes using the identical robotic arms and the same relative placement of the robotic arms in both systems 800 and 400. However, unlike trajectory transformation system 400, automated latte-drink-preparation system 800 does not need to include the tracking mechanism, i.e., Tracker1, Tracker2, and Tracker3, and the motion capture receiver presented in the relative trajectory transformation system 400.

Note that the first robotic arm 802 includes an end effector 804 for grasping a receiving cup 806, wherein end effector 804 is configured to securely grasp and hold receiving cup 806 between a pair of jaws of end effector 804. First robotic arm 802 also includes a non-rotating stand 808 firmly attached to the surface of table 830. End effector 804 can rotate around an axis affixed to the non-rotating stand 808, wherein the rotational motion of cup holder 804 is controlled by a first control program configured to execute the recorded rotational trajectory J3 from recording system 100 during a latte-drink making procedure to mimic the rotational/tilt motions of the receiving cup 106 of the human latte-making motion sequence performed in recording system 100 executed by user 150.

Note that the first robotic arm 802 can be configured in substantially the same manner as latte-making stage 102 in recording system 100. Although the embodiment in FIG. 8 shows first robotic arm 802 being implemented with a single-joint one-degree-of freedom (1-DOF) robotic arm, in other embodiments, first robotic arm 802 can also be implemented with a multi-joint, multi-degrees-of-freedom (multi-DOF) robotic arm without departing from the scope of this disclosure. For example, robotic arm 802 can also be implemented with a 3, 4, 5, 6, 7, or even more degrees-of-freedom (DOF) robotic arm to perform the same recorded rotational trajectory J3 during a fully-automated latte-drink making procedure to mimic the rotational/tilt motions of the receiving cup 106 in recording system 100.

As can be seen in FIG. 8, the second robotic arm 812 is a multi-DOF robotic arm that includes an end effector 814 firmly grasping and holding a pouring pitcher 810, wherein pouring pitcher 810 can be the same pouring pitcher or an identical copy of pouring pitcher 110 in recording system 100 and pouring pitcher 410 in transformation system 400. While the embodiment of second robotic arm 812 is shown to be a 6-DOF robotic arm, second robotic arm 812 can also be implemented with a robotic arm configured with greater than 6 DOF or less than 6 DOF. The motions of end effector 814 is controlled by a second control program configured to execute the transformed relative motion trajectory J_{W}^{EE}(tᵢ) during the same latte-drink making procedure to both (1) mimic the 3D motions of pouring pitcher 110 during the human latte-making motion sequence in recording system 100; and (2) compensate for the recorded unwanted movements of the latte-making stage 102 and the motion capture receiver 140 during the human latte-making motion sequence in recording system 100. Clearly, to accurately reproduce the recorded two-handed latte-making motion sequence in the latte-drink-preparation system 800, the execution of the transformed relative motion trajectory J_{W}^{EE}(tᵢ) and the execution of the recorded rotational trajectory J3 has to be time-synchronized to each other.

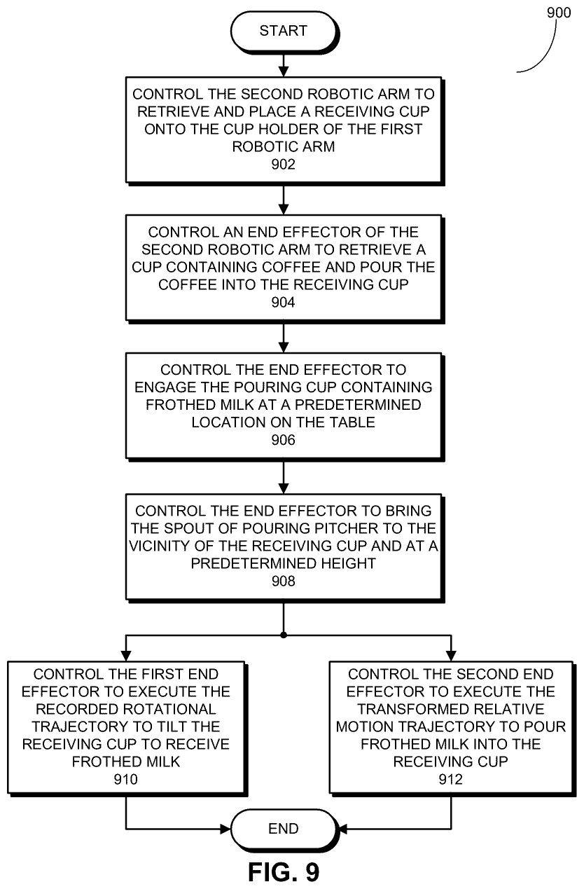

FIG. 9 presents a flowchart illustrating a process 900 for automatically creating a latte drink by executing the recorded human motion trajectories from recording system 100 using the two robotic arms of the latte-drink-preparation system 800 in accordance with some embodiments described herein. In one or more embodiments, one or more of the steps in FIG. 9 may be omitted, repeated, and/or performed in a different order. Accordingly, the specific arrangement of steps shown in FIG. 9 should not be construed as limiting the scope of the technique.

Process 900 may begin when a second end effector of second robotic arm 812 is controlled to retrieve and place a receiving cup onto the cup holder of first robotic arm 802 (step 902). Note that the second end effector can be different from end effector 814 for controlling the pouring pitcher 810. Next in process 900, end effector 814 of second robotic arm 812 is controlled to retrieve a transfer cup containing a predetermined amount of coffee and transfer the coffee by pouring the coffee from the transfer cup into the receiving cup (step 904). Next in process 900, end effector 814 of second robotic arm 412 is controlled to engage pouring pitcher 810 containing prepared frothed milk at a predetermined location on table 830. In some embodiments, the transfer cup is also pouring pitcher 810 (step 906).

Next in process 900, end effector 814 of second robotic arm 412 is controlled to bring the spout of the pouring pitcher into the vicinity of the receiving cup and at a predetermined (Z-) height above table 830 (step 908). In some embodiments, the predetermined height corresponds to a nominal Z-offset between the spout of the pouring pitcher and the top surface/rim of the receiving cup determined at the beginning of recording process 300 of FIG. 3 when there is just one receiving cup in the cup holder 804 of the first robotic arm 802. Next in process 900, end effector 804 of first robotic arm 802 is controlled to execute the recorded rotational trajectory J3 to tilt the receiving cup toward the pouring cup (step 910). Concurrently in process 900, end effector 814 of second robotic arm 812 is controlled to execute the transformed relative motion trajectory in its entirety which causes the frothed milk in pouring cup 810 to be poured into the receiving cup (step 914). Note that the executed transformed relative motion trajectory is composed of a milk-pour motion sequence (or the “milk-pour phase”) followed by a latte-art-generation motion sequence (or the “latte-art-generation phase”). Note also that steps 910 and 912 are executed time-synchronized to each other.

### Vision-Assisted Latte Art Creation

Note that in order to accurately execute the recorded two-handed latte-making motion sequence in latte-drink-preparation system 800 using the procedure described above in conjunction with FIG. 9, a number of initial replay conditions associated with receiving cup 806 and pouring pitcher 810 of the latte-drink-preparation system 800 have to be maintained at nominal levels for each case/instance of executing the recorded human motion trajectories. These initial liquid and cup conditions can include, but are not limited: (1) the initial frothed milk level in pouring pitcher 810; (2) the initial liquid level in receiving cup 806; and (3) the rim height of the receiving cup 806. However, each of these initial conditions is subject to a degree of variations from the nominal level from one instance to the next instant.

For example, the initial frothed milk level in pouring pitcher 810 can have an amount of variation from a nominal milk level, wherein the variation can be either above or below the nominal milk level, due to the dynamic nature of the milk frothing process. Moreover, the initial coffee level in receiving cup 806 can have an amount of variation from a nominal coffee level, wherein the variation can be either above or below the nominal coffee level. Additionally, the initial rim height of the receiving cup 806 can be higher than a nominal rim height due to more than one receiving cup being retrieved and placed on the cup holder in step 902 (referred to as “cup stacking”).

In order to accurately reproduce the recorded two-handed latte-making motion sequence on latte-drink-preparation system 800, these initial replay conditions can be monitored to detect the above-described variations and detected variations can be mitigated. This disclosure further provides a vision-guided recorded motion trajectory execution system and process which can be used in conjunction with process 900 to improve the accuracy, consistency, and speed of creating the latte art and completing a latte drink using process 900. As can be seen in FIG. 8, latte-drink-preparation system 800 can include a camera 820 configured to provide visual-guidance and visual-assistant to monitor/detect the above-described initial conditions during each instance of executing the recorded motion trajectories in latte-drink-preparation system 800. In some embodiments, camera 820 can be attached to the wrist of end effector 814 (as such also referred to as the “wrist camera”) and positioned to have an unobstructed view of the pouring motions during the replay of the recorded two-handed latte-making motion sequences.

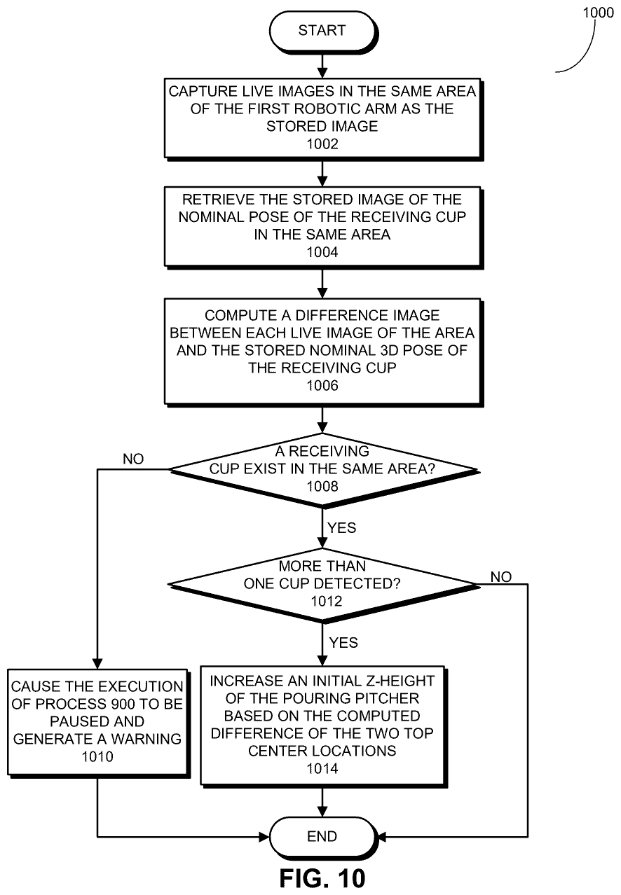

In some embodiments, after placing receiving cup 806 onto cup holder 804 of the first robotic arm 802 (i.e., step 902 in FIG. 2) but prior to pouring coffee into receiving cup 806 (i.e., step 902 in FIG. 2), a cup detection procedure can be performed to verify that at least one cup exists at the robotic arm 802 as well as the status of receiver cup 806 if at least one cup is detected. FIG. 10 presents a flowchart illustrating a process 1000 for performing vision-assisted real-time receiving cup detections at the beginning of the automated latte-art creating process 900 in accordance with some embodiments described herein. As mentioned above, process 1000 may take place between step 902 and step 904 in process 900. In one or more embodiments, one or more of the steps in FIG. 10 may be omitted, repeated, and/or performed in a different order. Accordingly, the specific arrangement of steps shown in FIG. 10 should not be construed as limiting the scope of the technique.

Note that before performing cup detection process 1000, a nominal 3D pose of receiving cup 806 in an upright position in cup holder 804 of the first robotic arm 802 is captured by camera 820 and stored, e.g., in a storage of robotic arm 812. Then, process 1000 may begin by capturing live images of the same area of robotic arm 802 as the stored image (step 1002). Next, process 1000 retrieves the stored image of a nominal pose of receiving cup 806 in the same area (step 1004). Process 1000 then computes a difference image between each live image of the area including cup holder 804 and the stored nominal 3D pose of receiving cup 806 (step 1006). For example, process 1000 can overlay the stored normal 3D pose image onto the captured live images when computing the differences between the stored image and the live images captured by camera 820 from exactly the same location. Next, process 1000 determines if a receiving cup exists at cup holder 804 based on the difference images (step 1008). If no cup is detected at step 1008, process 1000 may cause the execution of process 900 to be paused and optionally generate a warning (step 1010).

If receiving cup 806 is detected at step 1008, process 1000 further determines if there is more than one cup at cup holder 804 (i.e., a cup stacking event) based on the live camera images (step 1012). Note that a cup stacking event can occur in step 902 of process 900, when second robotic arm 812 accidentally retrieves and places more than one receiving cup (e.g., when two or three cups stuck together are retrieved) onto the cup holder of first robotic arm 802. In some embodiments, to detect a cup stacking event at step 1012, process 1000 can first extract both the top center location of the stored image of a normal single cup positioned at cup holder 804 and the top center location of the cup image within a live image of the cup holder area captured by camera 820. Process 1000 can detect a cup stacking event when the difference between the two top center locations extracted from the stored and live image is greater than a predetermined detection threshold (e.g., the predetermined detection threshold can be one half of the typical spacing between the top surfaces of two stacked cups).

If no cup stacking event is detected at step 1012, process 1000 can proceed to return to process 900 and process 1000 terminates. However, if a cup stacking event is detected at step 1012, process 1000 can increase the initial Z-height above table 830 of pouring pitcher 810 in step 908 of process 900 based on the computed difference of the top center locations (step 1014). More specifically, the initial Z-height of pouring pitcher 810 can be increased from the predetermined height to a modified Z-height by adding the computed difference of the top center locations to the predetermined height. Note that what this update does is to keep the Z-offset between the spout of the pouring pitcher and the top surface of the receiving cup to remain to be the nominal Z-offset. In other words, step 908 in the automated latte-art creating process 900 can be updated in real-time to mitigate the detected cup stacking event. Subsequently, process 1000 can return to process 900 and terminate.

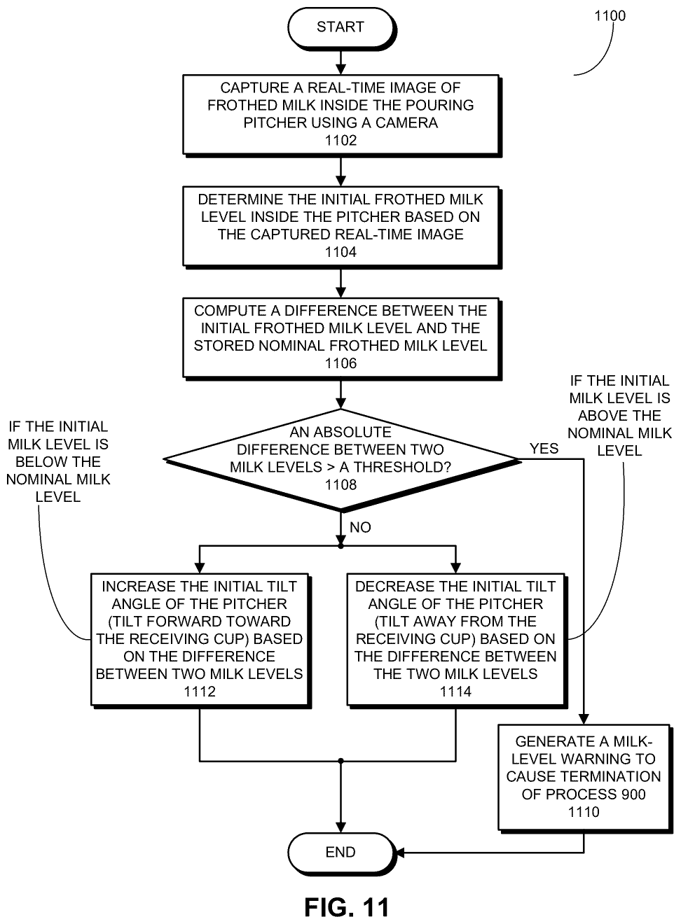

In some embodiments, after executing step 904 in process 900 but prior to engaging second robotic arm 812 on pouring pitcher 810 (i.e., step 906 in FIG. 9), a milk-level detection procedure can be performed to determine in real-time whether the initial milk level in pouring pitcher 810 is the same as a predetermined reference value. Alternatively, the disclosed milk-level detection procedure can also take place immediately after step 906 in process 900 but prior to executing step 908 in process 900. FIG. 11 presents a flowchart illustrating a process 1100 for performing vision-assisted real-time pitcher milk-level detection and variation mitigation during the automated latte-art creating process 900 in accordance with some embodiments described herein. As mentioned above, process 1100 may take place between step 904 and step 906 in process 900, or alternatively between step 906 and step 908 in process 900. In one or more embodiments, one or more of the steps in FIG. 11 may be omitted, repeated, and/or performed in a different order. Accordingly, the specific arrangement of steps shown in FIG. 11 should not be construed as limiting the scope of the technique.

Note that before performing milk-level detection procedure 1100, a nominal frothed milk level used for executing the two-handed latte-making motion sequence can be determined and stored at step 212 of process 200 during the setup of the teaching environment within recording system 100. Process 1100 may begin by capturing a real-time image of the frothed milk inside pouring pitcher 810 using camera 820 (step 1102). Note that the real-time image of the frothed milk level should be captured by camera 820 when camera 820 is positioned above the rim of pouring pitcher 810 which is set in the upright position on table 830. Hence, when the position of camera 820 attached to end effector 814 is already higher than the rim of pouring pitcher 810, the real-time image can be captured even after executing step 906 in process 900.

Next, process 1100 determines the initial frothed milk level inside pouring pitcher 810 based on the captured real-time image (step 1104). Process 1100 then computes a difference between the determined initial frothed milk level and the stored nominal frothed milk level (step 1106). Next, process 1100 determines if the absolute difference between the two milk levels is greater than a predetermined threshold (step 1108). If the computed difference between the two milk levels is greater than the predetermined threshold which indicates that the frothed milk level in the pouring pitcher 810 is too far off normal, process 1100 generates a milk-level warning which leads to the termination of process 900 (step 1110). However, if the computed difference between the two milk levels is less than the predetermined threshold, process 900 includes additional steps to mitigate the computed milk-level difference. Referring back to FIG. 9, note that step 908 in process 900 creates an initial tilt angle of pouring pitcher 810, and from that initial tilt angle, step 912 executes the transformed relative motion trajectory in its entirety. At the end of step 912 when the execution of the transformed relative motion trajectory is completed, pouring pitcher 810 is ended up with a final tilt angle, which is determined by both the initial tilt angle and the transformed relative motion trajectory, wherein the final tilt angle is generally a fixed angle.

A person of ordinary skill in the art will appreciate that the final tilt angle determines the amount of milk that remains in pouring pitcher 810 at the end of step 912. This means that, if the initial frothed milk level is below the nominal frothed milk level (i.e., there is less than a nominal amount of frothed milk in the pouring pitcher at the beginning of step 912) and the initial tilt angle is not changed from a nominal value learned from the recording procedure, a less than nominal amount of frothed milk will be poured into receiving cup 806, because the final tilt angle will remain to be the fixed final angle. Alternatively, if the initial frothed milk level is above the nominal frothed milk level (i.e., there is more than a nominal amount of frothed milk in the pouring pitcher at the beginning of step 912) and the initial tilt angle is not changed from the nominal value learned from the recording procedure, a more than nominal amount of frothed milk will be poured into receiving cup 806, for the same reason that the final tilt angle will remain to be the fixed final angle. However, either pouring more or pouring less than the nominal amount of frothed milk into receiving cup 806 while executing the transformed relative motion trajectory is not ideal and can lead to inaccuracy and/or inconsistency in the created latte art drink.

Equipped with the above understanding, one solution to mitigate the determined variations in the initial milk level is to modify the initial tilt angle of pouring pitcher 810. Returning to FIG. 11, if the absolute difference between the two milk levels is less than the predetermined threshold but the initial frothed milk level is determined to be below the nominal milk level at step 1108 (i.e., a less than the nominal amount of frothed milk in the pitcher), process 1100 then increases the initial tilt angle of pouring pitcher 810 from the nominal value (i.e., to have the spout of the pitcher tilted forward toward receiving cup 806) based on the computed difference between the milk levels (step 1112). Alternatively, if the absolute difference between the two milk levels is determined to be less than the predetermined threshold but the initial frothed milk level is above the nominal milk level at step 1108 (i.e., a greater than the nominal amount of frothed milk in the pitcher), process 1100 then decreases the initial tilt angle of pouring pitcher 810 from the nominal value (i.e., to have the spout of the pitcher tilted backward away from receiving cup 806) based on the computed difference between the milk levels (step 1114). The effect of the above-described initial tilt angle adjustments is to ensure that the amount of milk to be poured into receiving cup 806 during the execution of the transformed relative motion trajectory at step 912 to be relatively the same as a nominal amount of pour milk when no initial-tile-angle adjustment is needed. By integrating process 1100 with process 900, the automated latte-art creating process 900 can be updated/modified in real-time to mitigate the detected milk level variations inside pouring pitcher 810. Subsequently, process 1100 can return to process 900 and terminate.

As mentioned above, the initial liquid (e.g., coffee) level inside receiving cup 806 can also vary by a certain amount from a nominal liquid level at the end of step 904 of process 900. This variation should be mitigated because for consistency of creating the latte drink using process 900, the final liquid level in receiving cup 806 after receiving the frothed milk from pouring pitcher 810 should be the same or substantially the same each time, which means that it is undesirable to either overfill or underfill receiving cup 806. In some embodiments, the variations in the initial liquid (e.g., coffee) level inside receiving cup 806 can be mitigated through a vision-assisted adjustment procedure similar to process 1100 described above. Specifically, the initial liquid level can be first determined by capturing a real-time image of the receiving cup 806 from above the cup using camera 820. Next, in a similar manner as in process 1100, a difference between the determined initial liquid level and a nominal initial liquid level can be computed. Next, the initial tilt angle of pouring pitcher 810 can be modified based on the determined difference in the initial liquid levels.

Specifically, if the initial liquid level inside receiving cup 806 is determined to be above the nominal initial liquid level, the initial tilt angle of pouring pitcher 810 can be decreased from the nominal value (i.e., having the spout of pouring pitcher 810 tilted away/backward from receiving cup 806) based on the computed difference in the initial liquid levels. The effect of this initial tilt angle decrease is to reduce the amount of milk to be poured into receiving cup 806 during the execution of the transformed relative motion trajectory at step 912 in process 900, thereby keeping the final liquid level in receiving cup 806 to be relatively the same as a nominal liquid level for a nominally prepared latte-art drink when no adjustments are needed. Alternatively, if the initial liquid level inside receiving cup 806 is determined to be below the nominal initial liquid level, the initial tilt angle of pouring pitcher 810 can be increased from the nominal value (i.e., having the spout of pouring pitcher 810 tilted forward toward receiving cup 806) based on the computed difference in the initial liquid levels. The effect of this initial tilt angle increase is to increase the amount of milk to be poured into receiving cup 806 during the execution of the transformed relative motion trajectory at step 912 in process 900, thereby also keeping the final liquid level in receiving cup 806 to be relatively the same as the nominal liquid level for the nominally prepared latte art drink when no initial-tilt-angle adjustment is needed.

In some embodiments, the variation where the initial liquid (e.g., coffee) level inside receiving cup 806 is above the nominal level can be mitigated in real-time during execution of the transformed relative motion trajectory at step 912 of process 900. Specifically, during the milk-pouring phase of the execution of the recorded latte-making motion sequence within step 912, the real-time liquid level within receiving cup 806 can be continuously monitored by camera 802, and a difference between the real-time liquid level inside receiving cup 806 and a target liquid level to terminate the milk-pour phase of the execution of the transformed relative motion trajectory is continuously determined. When it is determined that the real-time liquid level inside receiving cup 806 has reached the target liquid level, robotic arm 812 can be programmed to stop executing the milk-pouring phase of the transformed relative motion trajectory and start executing the latte-art-making phase of the transformed relative motion trajectory.

As can be seen, using the disclosed vision-assisted motion trajectory execution system and process, during the automated robot latte-making/reproduction process, the initial conditions for executing the recorded latte-making motion sequence can be changed/modified in real-time is a number of ways, e.g., by changing the initial tilt angle and/or the initial z-height of the pouring pitcher, wherein the amount change/adjustment can be determined in real-time based on the real-time captured images of the pouring pitcher and receiving cup.

### Overall Robotic Beverage-Preparation System

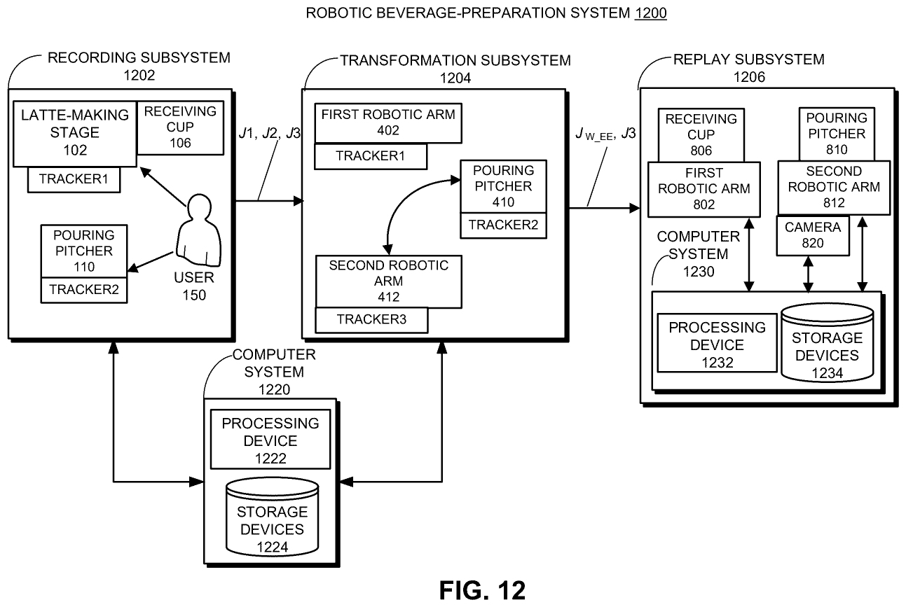

FIG. 12 illustrates a block diagram of an overall robotic beverage-preparation system 1200 for teaching and using a multi-arm robot to imitate two-handed human latte-making motions to create latte drinks in accordance with some embodiments described herein. As shown in FIG. 12, robotic beverage-preparation system 1200 can include a recording subsystem 1202, a transformation subsystem 1204, and a replay subsystem 1206, which are coupled in the manner shown. Note that recording subsystem 1202 includes a human user, physical objects, hardware components, and software programs configured to operate collectively to perform the designated teaching and recording functions. Note that transformation subsystem 1204 includes a human user, physical objects, hardware components, and software programs configured to operate collectively to perform the designated calibration and transformation functions. Replay subsystem 1206 includes physical objects, hardware components, and software programs configured to operate collectively to perform the designated latte-drink-preparation functions. Note that robotic beverage-preparation system 1200 can consistently and repeatedly reproduce copies of a given type of latte drink as its output.

In some embodiments, recording subsystem 1202 is implemented in accordance with either system 100 of FIG. 1A or system 101 of FIG. 1B. More specifically, recording subsystem 1202 includes a latte-making stage 102 implemented with a first robotic arm. Subsystem 1202 includes two motion trackers: Tracker1 which is attached to a non-rotational part of the latte-making stage 102 and Tracker2 which is attached to a pouring pitcher 110. During a synchronized two-handed latte-making motion sequence performed by user 150 such as a human barista, Tracker1 and Tracker2 are used to record the two motion trajectories J1 and J2 with respect to the same reference point. More specifically, J1 captures and records the non-rotational movements of the latte-making stage 102, including the motions caused by any movement of the recording platform/table during the latte-making motion sequence. J2 captures and records the milk-pouring motions (including the latte art action sequence) of the two-handed latte-making motion sequence. Moreover, during the latte-making motion sequence, position sensors/transducers embedded in latte-making stage 1212 capture and record rotational motion trajectory J3 (if implemented as recording system 100) or multiple joint motion trajectories (if implemented as recording system 101) caused by user 150 tilting the receiving cup 106 on latte-making stage 102 while receiving the poured milk from the pouring pitcher 110. In some embodiments, the relative motion trajectory J_{Tkr1}^{Tkr2} can then be computed in recording subsystem 1202 based on Eqn. 5.

Recording subsystem 1202 is communicably coupled to a computer system 1220. As can be seen in FIG. 12, computer system 1220 includes a processing device 1222 and one or more storage devices 1224. Processing device 1222 executes computer instructions stored in storage devices 1224, for example, one or more programs for controlling the recording of the set of motion trajectories J1, J2, and J3 by the corresponding set of motion capturing devices. Computer system 1220 can be a client, a server, a computer, a smartphone, a PDA, a laptop, or a tablet computer with one or more processors embedded therein or coupled thereto, or any other sort of computing device. Such a computer system includes various types of computer-readable media and interfaces for various other types of computer-readable media. Processing device 1222 can include any type of processor, including, but not limited to, a microprocessor, a graphic processing unit (GPU), a tensor processing unit (TPU), an intelligent processor unit (IPU), a digital signal processor (DSP), a field-programmable gate array (FPGA), and an application-specific integrated circuit (ASIC). Processing device 1222 can be a single processor or a multi-core processor in different implementations. Storage devices 1224 can include a read-only memory (ROM) device, a permanent storage device, and a read-and-write memory device, such as a random access memory (RAM).

As mentioned above, to record a set of optimal motion trajectories J1, J2, and J3, user 150 can repeatedly perform the synchronized two-handed latte-making motion sequence within subsystem 1202, wherein each repetition made by user 150 represents a different attempt to teach the two-handed latte-making motion sequence. Meanwhile, the set of trajectories J1, J2, and J3 can be repeatedly recorded during each repetition by user 150 until an optimal result of the latte drink is achieved inside the receiving cup.

Referring back to robotic beverage-preparation system 1200, note that transformation subsystem 1204 is coupled to recording subsystem 1202 to receive the set of trajectories J1, J2, and J3, and subsequently compute the relative motion trajectory J_{Tkr1}^{Tkr2} (or alternatively directly receiving the relative motion trajectory J_{Tkr1}^{Tkr2} and J3). As described above, to automatically replicate the recorded synchronized two-handed latte-making motion sequence using the two robotic arms, one robotic arm can be programmed and controlled to execute the relative motion trajectory by grasping the pouring pitcher while the other robotic arm can be programmed and controlled to execute the rotational trajectory J3 by holding the receiving cup. However, because the end effector of a given robotic arm executes a given pose with respect to the world coordinate system (WCS), e.g., the center of the given robotic arm's base, each pose in the relative motion trajectory J_{Tkr1}^{Tkr2} must be transformed into a corresponding pose of the end effector of the second robotic arm with respect to the WCS.

Transformation subsystem 1204 is configured to perform the above-described pose/trajectory transformation procedures using both a first robotic arm 402 configured as the latte-making stage (which can be identical to latte-making stage 102 in recording subsystem 1202), and the second multi-DOF robotic arm 412 for manipulating pouring pitcher 410 (which can be the same as pouring pitcher 110) in place of the human hand in recording subsystem 1202. To perform the pose transformation in transformation subsystem 1204, Tracker1 which is attached to a non-rotational part of the first robotic arm 402 and Tracker2 which is attached to pouring pitcher 410 are also included in transformation subsystem 1204. Moreover, a third pose/motion tracking device “Tracker3” is used in transformation subsystem 1204 and placed at a fixed location in the WCS, such as being mounted onto the base of the second robotic arm 412.

Transformation subsystem 1204 is also communicably coupled to computer system 1220. Processing device 1222 executes computer instructions stored in storage devices 1224, including various calibration and transformation programs for transforming the relative motion trajectory J_{Tkr1}^{Tkr2} into the transformed relative motion trajectory J_{W}^{EE} described in conjunction with FIGS. 5-7. As a result, transformation subsystem 1204 produces the transformed relative motion trajectory J_{W}^{EE} as the replay trajectory for the end effector of the second robotic arm 402 with respect to the WCS.

Note that replay subsystem 1206 is coupled to transformation subsystem 1204 to receive the set of trajectories J_{W}^{EE} and J3. Replay subsystem 1206 includes the first robotic arm 802 implementing the latte-making stage that controls the tilt angles of receiving cup 806 and the second robotic arm 812 that controls the pouring motions of the pouring pitcher 810. Note that the first robotic arm/latte-making stage 802 in replay subsystem 1206 can be substantially identical to the first robotic arm/latte-making stage 402 in transformation subsystem 1204, but without Tracker1. Note that the second robotic arm 812 in replay subsystem 1206 can be substantially identical to the second robotic arm 412 in transformation subsystem 1204, but without Tracker3. Moreover, pouring pitcher 810 in replay subsystem 1206 does not have Tracker2 attached to it.

Replay subsystem 1206 includes a computing system 1230 communicably coupled to the first and second robotic arms 802 and 812. As can be seen in FIG. 12, computer system 1230 includes a processing device 1232 and one or more storage devices 1234. Processing device 1232 executes computer instructions stored in storage devices 1234, including one or more programs for replaying the received trajectories J3 and J_{W}^{EE}(tᵢ) on the end effectors of the first and the second robotic arms 802 and 812, as described above in conjunction with process 900, thereby generating consistent copies of the latte drink taught by user 150. Computer system 1230 can be a client, a server, a computer, a smartphone, a PDA, a laptop, or a tablet computer with one or more processors embedded therein or coupled thereto, or any other sort of computing device. Such a computer system includes various types of computer-readable media and interfaces for various other types of computer-readable media. Processing device 1232 can include any type of processor, including, but not limited to, a microprocessor, a graphic processing unit (GPU), a tensor processing unit (TPU), an intelligent processor unit (IPU), a digital signal processor (DSP), a field-programmable gate array (FPGA), and an application-specific integrated circuit (ASIC). Processing device 1232 can be a single processor or a multi-core processor in different implementations. Storage devices 1234 can include a read-only memory (ROM) device, a permanent storage device, and a read-and-write memory device, such as a random access memory (RAM).

In some embodiments, replay subsystem 1206 also includes a vision-assisted mechanism including camera 820 which provides real-time monitoring variations of a number of initial replay conditions before replaying the received trajectories J3 and J_{W}^{EE} on the end effectors of the two robotic arms. As described above, these initial replay conditions can include but are not limited: (1) the initial frothed milk level in pouring pitcher 810; (2) the initial liquid level in receiving cup 806; and (3) a cup stacking event associated with receiving cup 806 on the first robotic arm 802. Hence, processing device 1232 can execute computer instructions and programs stored in storage devices 1234, including various real-time replay condition mitigation processes described in conjunction with FIGS. 10 and 11, as well as the described receiving cup liquid level mitigation process.

While this patent document contains many specifics, these should not be construed as limitations on the scope of any disclosed technology or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A computer-implemented method of teaching a multi-arm robot to imitate a two-handed beverage-preparation motion sequence performed by a human, comprising:
recording, in a teaching environment, two or more motion trajectories during the two-handed beverage-preparation motion sequence;
transforming the recorded two or more motion trajectories into a motion trajectory of an end effector of a first robotic arm; and
reproducing the two-handed beverage-preparation motion sequence by executing the transformed motion trajectory on an end effector of the first robotic arm.

2. The computer-implemented method of claim 1, wherein recording the two or more motion trajectories during the two-handed beverage-preparation motion sequence includes:
coupling a first motion tracker on a first vessel controlled by one hand of the two-handed beverage-preparation motion sequence;
coupling a second motion tracker on a second vessel controlled by the other hand of the two-handed beverage-preparation motion sequence; and
generating a relative motion trajectory representing relative movements between the first vessel and the second vessel during the two-handed beverage-preparation motion sequence using the first motion tracker and the second motion tracker.

3. The computer-implemented method of claim 2, wherein generating the relative motion trajectory representing the relative movements further includes:
using the first motion tracker and a motion capture receiver to generate a first motion trajectory of the first vessel during the two-handed beverage-preparation motion sequence;
using the second motion tracker and the motion capture receiver to generate a second motion trajectory of the second vessel during the two-handed beverage-preparation motion sequence; and
combining the first motion trajectory and the second motion trajectory to obtain the relative motion trajectory.

4. The computer-implemented method of claim 3, wherein the first motion trajectory and the second motion trajectory are time-synchronized to each other.

5. The computer-implemented method of claim 3, wherein the first motion trajectory and the second motion trajectory are generated with respect to a common reference point located on the motion capture receiver.

6. The computer-implemented method of claim 2, wherein transforming the recorded two or more motion trajectories into the motion trajectory of the end effector includes transforming the relative motion trajectory into the motion trajectory of the end effector with respect to a world reference frame fixed to the base of the first robotic arm.

7. The computer-implemented method of claim 6, wherein transforming the relative motion trajectory into the motion trajectory of the end effector with respect to the world reference frame includes:
determining a first transformation from a first reference frame of the first motion tracker attached to the first vessel to the world reference frame;
determining a second transformation from a second reference frame of the end effector to the world reference frame;
determining a third transformation from the second reference frame of the end effector to the first reference frame of the first motion tracker based on the first transformation and the second transformation;
determining a fourth transformation from a third reference frame of the second motion tracker attached to the second vessel to the world reference frame; and
applying the third transformation and the fourth transformation to the relative motion trajectory to obtain the transformed motion trajectory of the end effector with respect to the world reference frame.

8. The computer-implemented method of claim 7, wherein prior to determining the second transformation from the second reference frame of the end effector to the world reference frame, the method further comprises:
positioning the first vessel in an upright position at an initial location on a table; and
engaging the end effector with the first vessel at a designated grasping point on the first vessel.

9. The computer-implemented method of claim 8, wherein determining the second transformation from the second reference frame of the end effector to the world reference frame further includes applying a forward kinematics technique to the first robotic arm after engaging the end effector with the first vessel.

10. The computer-implemented method of claim 3, wherein recording the two or more motion trajectories during the two-handed beverage-preparation motion sequence further includes:
attaching the second vessel onto a rotational stage; and
recording, in the teaching environment, a third motion trajectory of the second vessel representing a rotational motion sequence of the second vessel caused by the other hand.

11. The computer-implemented method of claim 10, wherein reproducing the two-handed beverage-preparation motion sequence further includes:
executing the third motion trajectory on an end effector of a second robotic arm, wherein executing the third motion trajectory is time-synchronized with executing the transformed motion trajectory.

12. The computer-implemented method of claim 2, wherein:
the first vessel is a frothed-milk pouring cup;
the second vessel is a receiving cup; and
the two-handed beverage-preparation motion sequence is a latte-making motion sequence.

13. A system for teaching a multi-arm robot to imitate two-handed beverage-preparation motions performed by a human, comprising:
one or more processors; and
a memory coupled to the one or more processors;
wherein the memory stores a set of instructions that, when executed by the one or more processors, cause the system to:
record two or more motion trajectories during the two-handed beverage-preparation motion sequence;
transform the recorded two or more motion trajectories into a motion trajectory of an end effector of a first robotic arm; and
reproduce the two-handed beverage-preparation motion sequence by executing the transformed motion trajectory on an end effector of the first robotic arm.

14. The system of claim 13, wherein the memory further stores a set of instructions that, when executed by the one or more processors, cause the system to record the two or more motion trajectories during the two-handed beverage-preparation motion sequence by:
coupling a first motion tracker on a first vessel controlled by one hand of the two-handed beverage-preparation motion sequence;
coupling a second motion tracker on a second vessel controlled by the other hand of the two-handed beverage-preparation motion sequence; and
generating a relative motion trajectory representing relative movements between the first vessel and the second vessel during the two-handed beverage-preparation motion sequence using the first motion tracker and the second motion tracker.

15. The system of claim 14, wherein the memory further stores a set of instructions that, when executed by the one or more processors, cause the system to generate the relative motion trajectory by:
using the first motion tracker and a motion capture receiver to generate a first motion trajectory of the first vessel during the two-handed beverage-preparation motion sequence;
using the second motion tracker and the motion capture receiver to generate a second motion trajectory of the second vessel during the two-handed beverage-preparation motion sequence; and
combining the first motion trajectory and the second motion trajectory to obtain the relative motion trajectory.

16. The system of claim 15, wherein the first motion trajectory and the second motion trajectory are time-synchronized to each other.

17. The system of claim 15, wherein the first motion trajectory and the second motion trajectory are generated with respect to a common reference point located on the motion capture receiver.

18. The system of claim 14, wherein the memory further stores a set of instructions that, when executed by the one or more processors, cause the system to transform the recorded two or more motion trajectories into the motion trajectory of the end effector by transforming the relative motion trajectory into the motion trajectory of the end effector with respect to a world reference frame fixed to the base of the first robotic arm.

19. The system of claim 18, wherein the memory further stores a set of instructions that, when executed by the one or more processors, cause the system to transform the relative motion trajectory into the motion trajectory of the end effector with respect to the world reference frame by:
determining a first transformation from a first reference frame of the first motion tracker attached to the first vessel to the world reference frame;
determining a second transformation from a second reference frame of the end effector to the world reference frame;
determining a third transformation from the second reference frame of the end effector to the first reference frame of the first motion tracker based on the first transformation and the second transformation;
determining a fourth transformation from a third reference frame of the second motion tracker attached to the second vessel to the world reference frame; and
applying the third transformation and the fourth transformation to the relative motion trajectory to obtain the transformed motion trajectory of the end effector with respect to the world reference frame.

21. A system for encoding a synchronized two-handed latte-making motion sequence performed by a human barista, comprising:
a latte-making stage affixed onto a table, wherein the latte-making stage is integrated with at least one position transducer;
a receiving cup controlled by one hand of the human barista performing the synchronized two-handed latte-making motion sequence, wherein the receiving cup is attached to a rotation part of the latte-making stage;
a first motion tracker coupled to a non-rotational part of the latte-making stage;
a pouring pitcher controlled by the other hand of the human barista performing the synchronized two-handed latte-making motion sequence;
a second motion tracker coupled to the pouring pitcher; and
a motion capture receiver communicatively coupled to the first motion tracker and the second motion tracker;
wherein the first motion tracker and the motion capture receiver are configured to generate a first motion trajectory of the latte-making stage during the synchronized two-handed latte-making motion sequence;
wherein the second motion tracker and the motion capture receiver are configured to generate a second motion trajectory of the pouring pitcher during the synchronized two-handed latte-making motion sequence,
wherein the at least one position transducer is configured to generate a rotational motion trajectory of the receiving cup during the synchronized two-handed latte-making motion sequence, and
wherein the first motion trajectory, the second motion trajectory, and the rotational motion trajectory encode the synchronized two-handed latte-making motion sequence.
